(19) United States
(12) Patent Application Publication
(10) Pub. No.: US 2015/0232357 A1
(43) Pub. Date: Aug. 20, 2015

(54) REAL-TIME SYSTEM AND PROCESSES FOR CONTROLLING OZONE GAS

(71) Applicant: CLEAN LIQUID, LLC, San Luis Obispo, CA (US)

(72) Inventors: Charles Robert Moncrief, III, Arroyo Grande, CA (US); Bryan Dennis Childress, Arroyo Grande, CA (US); Arthur Andrew Wyrick, Bodfish, CA (US)

(21) Appl. No.: 14/576,206

(22) Filed: Dec. 19, 2014

Related U.S. Application Data
(60) Provisional application No. 61/921,402, filed on Dec. 27, 2013.

(51) Int. Cl. C02F 1/78

(52) U.S. Cl. CPC C02F 1/78; C02F 2303/04; C02F 2103/04

(57) ABSTRACT

A water treatment system and process for removing pathogens and contaminants from water or wastewater by treating source water with ozone. The system includes monitoring sensors that track water properties in real-time and controls ozone output in order to increase the efficiency of the ozone treatment system. The ozone in the water is automatically controlled by one or more control processes, which are in turn controlled by a master control process, allowing the effluent water quality to meet specific pathogen and contaminant limits An ozone dose table is used to determine ozone dosage based on influent water quality, water treatment system properties and pathogen and contaminant limits in the effluent water.

This application claims the benefit of U.S. Provisional Application No. 61/921,402, filed Dec. 27, 2013, for REAL-TIME SYSTEM AND PROCESSES FOR CONTROLLING OZONE GAS, which is incorporated in its entirety herein by reference.

### BACKGROUND OF THE INVENTION

1. Field of the Invention

The present invention relates generally to water and wastewater treatment, and more specifically to systems and processes for chemically oxidizing contaminants and pathogens in water by mixing ozone into water.

2. Discussion of the Related Art

Public Health departments regulate the treatment of drinking water and wastewater. Drinking water must be treated to meet minimum requirements for removal of specific contaminants and pathogens before entering the public system. Contaminants found in water can include pharmaceuticals, N-Nitrosodiummethylamines (known carcinogens), and personal care products. Pathogens found in water can include poliovirus and MS2 coliphage. Wastewater must also meet minimum requirements, although the requirements vary depending on whether the wastewater is to be released into the natural environment or to be recycled as irrigation or potable water. Heightened awareness of the risks to human health posed by contaminants and pathogens has led to the imposition of stricter limits on levels of pathogens and contaminants in treated water.

Various methods are used to treat water. They include, but are not limited to, coagulation, sedimentation, filtration and disinfection. Disinfection is the removal, deactivation or killing of pathogenic microorganisms. Disinfection can be attained by means of physical or chemical disinfectants. The disinfectants also remove organic contaminants from water, which serve as nutrients or shelters for microorganisms.

Some currently available disinfection methods include chlorination, ozonation and ultraviolet light. Ozone (O₃), a chemical disinfectant, destroys contaminants and pathogens by sacrificing one oxygen atom to oxidize a pathogen or contaminant, thus destroying it. Other mechanisms of ozone disinfection include formation of the free radicals hydrogen peroxy and hydroxyl which are also powerful oxidizers. The high oxidation potential of ozone also makes it an effective decontaminant. The overall effectiveness of ozone disinfection and decontamination depends on the oxidation susceptibility of target contaminants and pathogens, contact time (amount of time dissolved ozone remains in the water) and concentration of dissolved ozone in the water. An ozone disinfection and decontamination system strives for the maximum solubility of ozone in wastewater, as treatment efficacy increases with the amount of ozone dissolved in the water.

Use of ozone as a decontaminant and disinfectant produces few dangerous by-products and does not affect the taste or odor of water. Ozonation also utilizes a short contact time. However, ozone gas not dissolved in the water must be removed prior to release of the treated water and destroyed to ensure worker safety.

A major cost of ozone water treatment is the electricity used to generate the ozone on site. In addition, if excess ozone is produced, additional costs are incurred in destroying the excess ozone. Because the chemical reactions occurring in ozone decontamination and disinfection of wastewater are more complex than those for ozone disinfection and decontamination of drinking water, it is difficult to accurately determine the amount of ozone required to meet specific water standards while using a minimum amount of ozone. Systems and processes to increase the efficiency of ozone treatment are increasingly needed as acceptable levels of pathogens and contaminants in water and wastewater become stricter.

### SUMMARY OF THE INVENTION

In accordance with one embodiment, the present invention can be characterized as a water treatment system comprising a plurality of monitoring sensors tracking properties in real-time; and a controller controlling ozone output in response to the plurality of monitoring sensors tracking properties and in response to an ozone dose table for determining ozone dosage based on pathogen and contaminant limits for effluent water.

In accordance with another embodiment, the present invention can be characterized as a water treatment method comprising sensing in real-time; generating a plurality of sensor outputs in response to said sensing; and controlling ozone output in response to the plurality of sensor outputs and in response to an ozone dose table for determining ozone dosage based on pathogen and contaminant limits for effluent water.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic diagram of an ozone water treatment system according to one embodiment of the present invention.

FIG. 2 is a schematic diagram of an ozone water treatment system according to a further embodiment of the present invention.

FIG. 3, comprised of partial view FIGS. 3A and 3B, is a schematic diagram of an ozone gas source according to one embodiment of the invention.

FIG. 4 is a flow diagram of a generalized ozone treatment process control that is, in accordance with one variation, carried out by the embodiment of FIG. 1.

FIG. 5 is a flow diagram of an ozone transfer efficiency process control that is, in accordance with one variation, carried out by the embodiment of FIG. 1.

FIG. 6 is a flow diagram of a master process control and a plurality of sub-processes that is, in accordance with one variation, carried out by the embodiment of FIG. 1.

FIG. 7 is a schematic diagram of a first ozone water treatment system display panel in accordance with a further variation of the embodiment of FIG. 1.

FIG. 8 is a schematic diagram of a second ozone water treatment system display panel in accordance with a further variation of the embodiment of FIG. 1.

FIG. 9 is a schematic diagram of a system control display panel in accordance with a further variation of the embodiment of FIG. 1.

FIG. 10 is a schematic diagram of a portion of the system control display panel as shown in FIG. 9.

FIG. 11 is a table showing the ozone dose required for pathogen reduction in accordance with another variation of the embodiment of FIG. 1.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

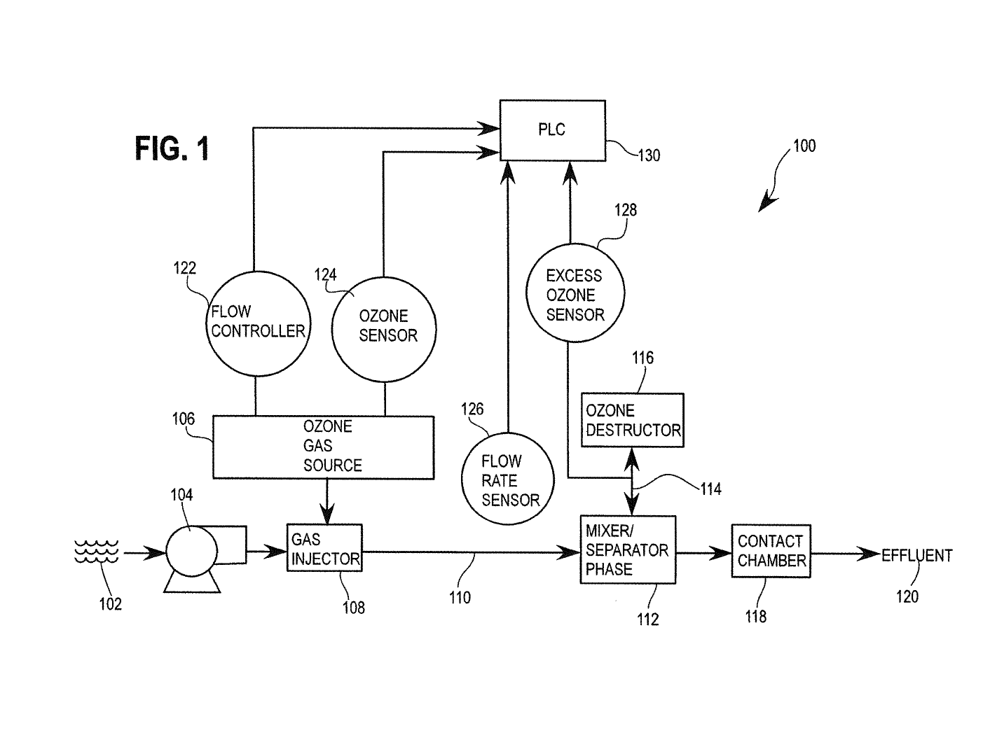

Referring first to FIG. 1, a diagram of an ozone water treatment system 100 is shown in accordance with one embodiment of the invention. Shown are an influent water source 102, a booster pump 104, an ozone gas source 106, a gas injector 108, an ozone-saturated water conduit 110, a mixer/separator phase 112, an excess ozone gas conduit 114, an ozone destructor 116, a contact chamber 118, an effluent water stream 120, a flow controller 122, an ozone sensor 124, an ozone-saturated water flow rate sensor 126, an excess ozone gas sensor 128, and a programmable logic controller (PLC) 130.

The influent water source 102 may be comprised of any water source requiring treatment for disinfection, contamination, odor, or any other effect provided by ozone treatment. Examples of influent water sources 102 for ozone water treatment include wastewater with prior primary and secondary treatments and drinking water. The influent water source 102 is fluidly coupled to the intake of the booster pump 104, for example, by an intake conduit or pipe.

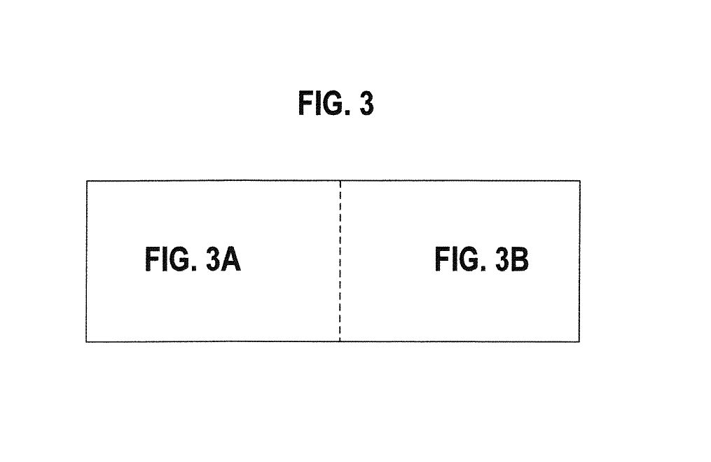

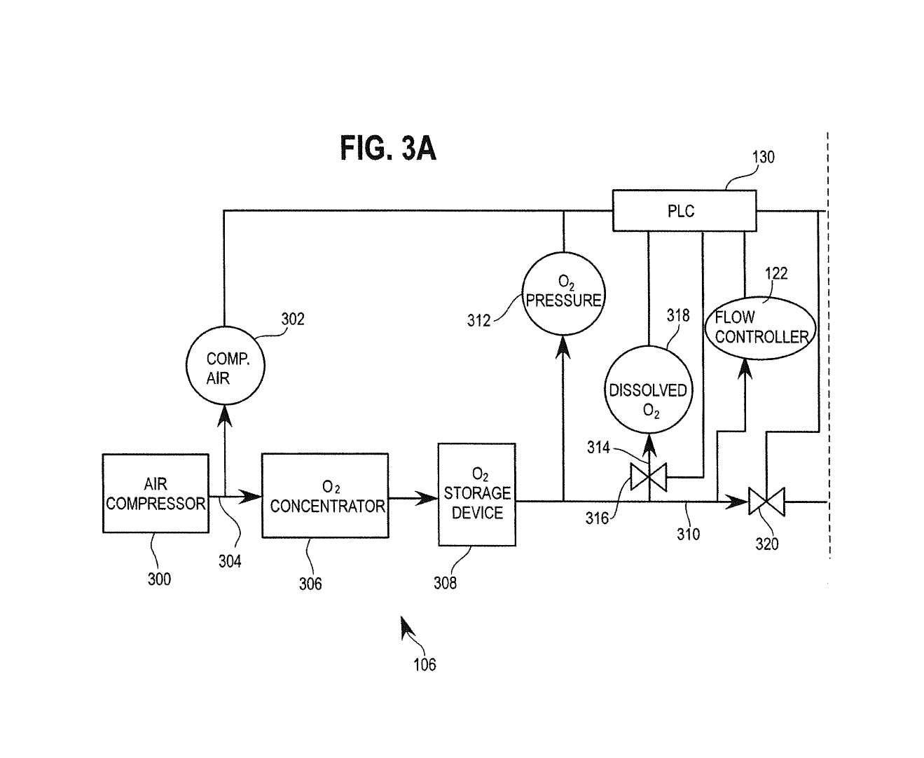

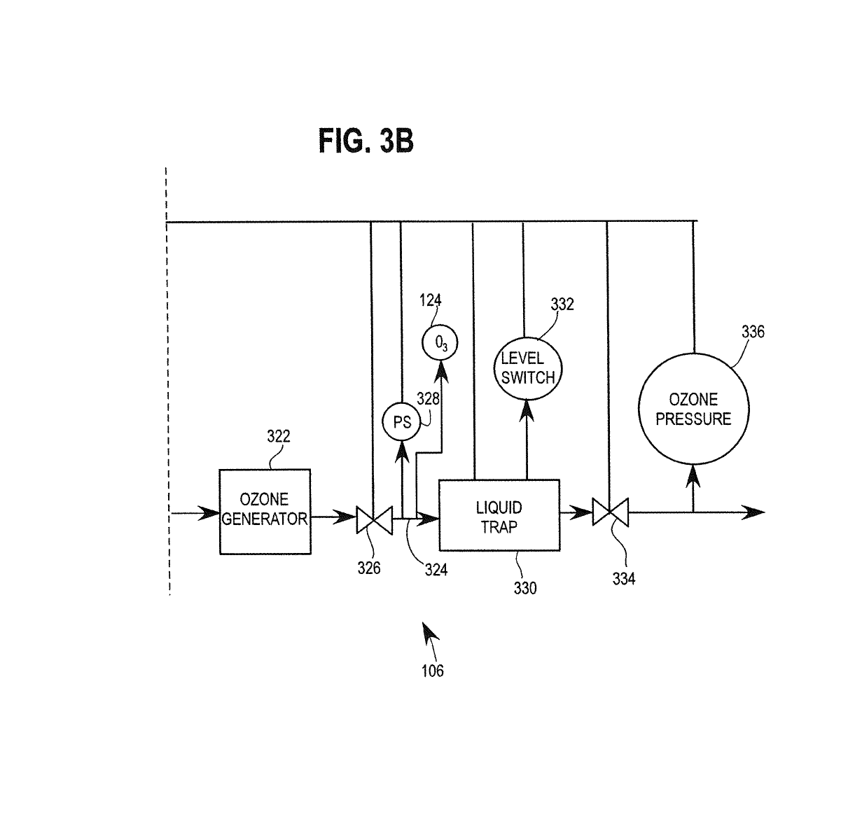

The discharge of the booster pump 104 is fluidly coupled, for example by a pipe or other conduit, to the water intake of the gas injector 108. The gas intake of the gas injector 108 is also fluidly coupled, for example by a pipe or other conduit, to the ozone gas source 106 of the ozone water treatment system 100. One embodiment of the ozone gas source 106 of the ozone water treatment system 100 is described below in FIG. 3. In the present embodiment of the invention, the gas injector 108 is a venturi injector. Alternate gas transfer devices include diffuser type transfer devices. The flow controller 122 and the ozone sensor 124 are in fluid communication with the ozone gas source 106, and are described in greater detail in FIG. 3. The flow controller 122 and the ozone sensor 124 transfer data to the programmable logic controller (PLC) 130 using wires, wireless signals, or other method of transferring data. The programmable logic controller 130 typically comprises hardware and software as required to receive and analyze data and to regulate the ozone water treatment system 100 based on input by the user.

The discharge of the gas injector 108 is fluidly coupled, for example by a pipe or other conduit, to the upstream end of the ozone-saturated water conduit 110. The ozone-saturated water conduit 110 is of size and composition as required by the ozone-saturated water stream properties, flow rate and water volume. The ozone-saturated water flow rate sensor 126 is in fluid communication with the ozone-saturated water stream flowing through the ozone-saturated water conduit 110. The ozone-saturated water flow rate sensor 126 transfers data to the programmable logic controller (PLC) 130 using wires, wireless signals, or other method of transferring data.

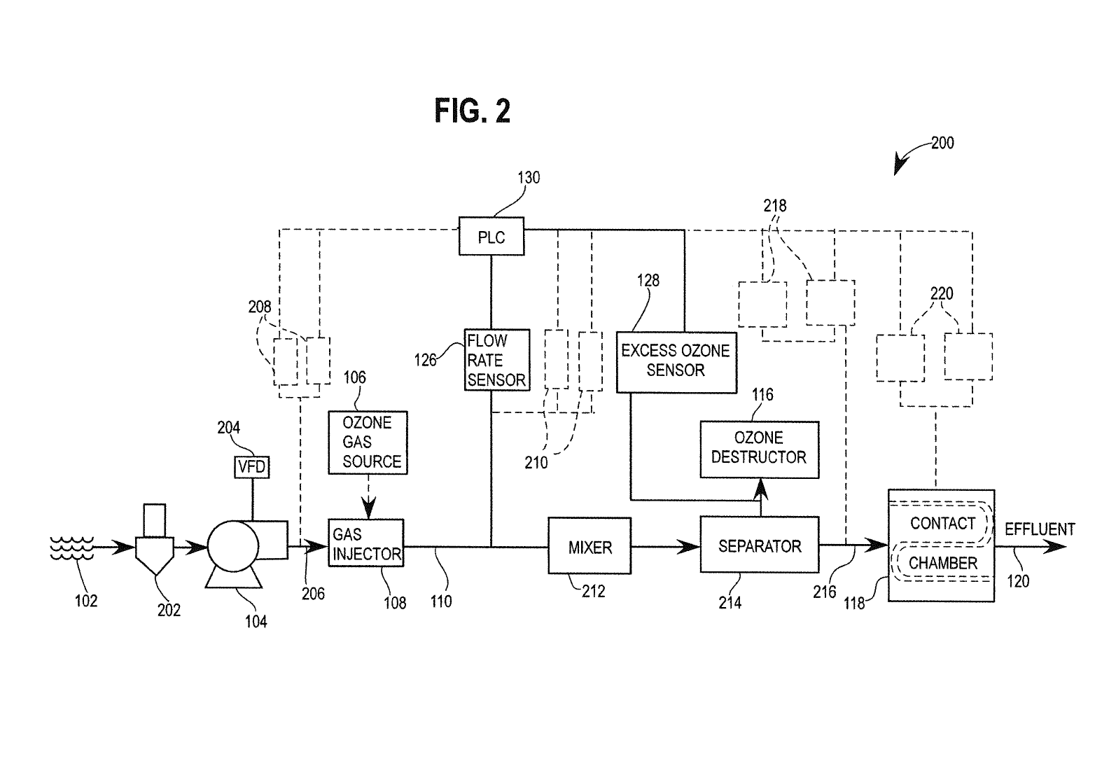

The downstream end of the ozone-saturated water conduit 110 is fluidly coupled, for example by a pipe or other conduit, to the intake of the mixer/separator phase 112. One embodiment of the mixer/separator phase 112 is described in more detail in FIG. 2. The ozone gas discharge of the mixer/separator phase 112 is fluidly coupled by the excess ozone gas conduit 114 to the intake of the ozone destructor 116.

The excess ozone gas sensor 128 is in fluid communication with the excess ozone gas stream flowing through the excess ozone gas conduit 114. The excess ozone gas sensor 128 transfers data to the programmable logic controller (PLC) 130 using wires, wireless signals, or other method of transferring data.

The water discharge of the mixer/separator phase 112 is fluidly coupled, for example by a pipe or other conduit, to the intake of the contact chamber 118. The contact chamber 118 is of size, shape and configuration as required by the influent water quality, desired treatment level and site conditions. The contact chamber 118 of the present embodiment of the present invention is a serpentine type chamber. The fully treated effluent water stream 120 exits the discharge of the contact chamber 118.

Referring again to FIG. 1, the influent water source 102 is pumped through the booster pump 104 in order to control the influent water stream flow rate. The skilled artisan will recognize that additional pumps 104 may be added to the ozone water treatment system 100 as needed to provide the required ozone water treatment system 100 water flow rate.

The influent water source 102 exits the booster pump 104 and flows into the water intake of the gas injector 108. The ozone gas source 106 discharges ozone gas into the gas intake of the gas injector 108. One embodiment of the ozone gas source 106 is described in more detail in FIG. 3. As the influent water source 102 and ozone gas enter the gas injector 108, the gas injector 108 transfers the ozone gas into the influent water source 102. The ozone gas dissolved into the influent water source 102 is then available to chemically react with and eliminate contaminants and pathogens in the water.

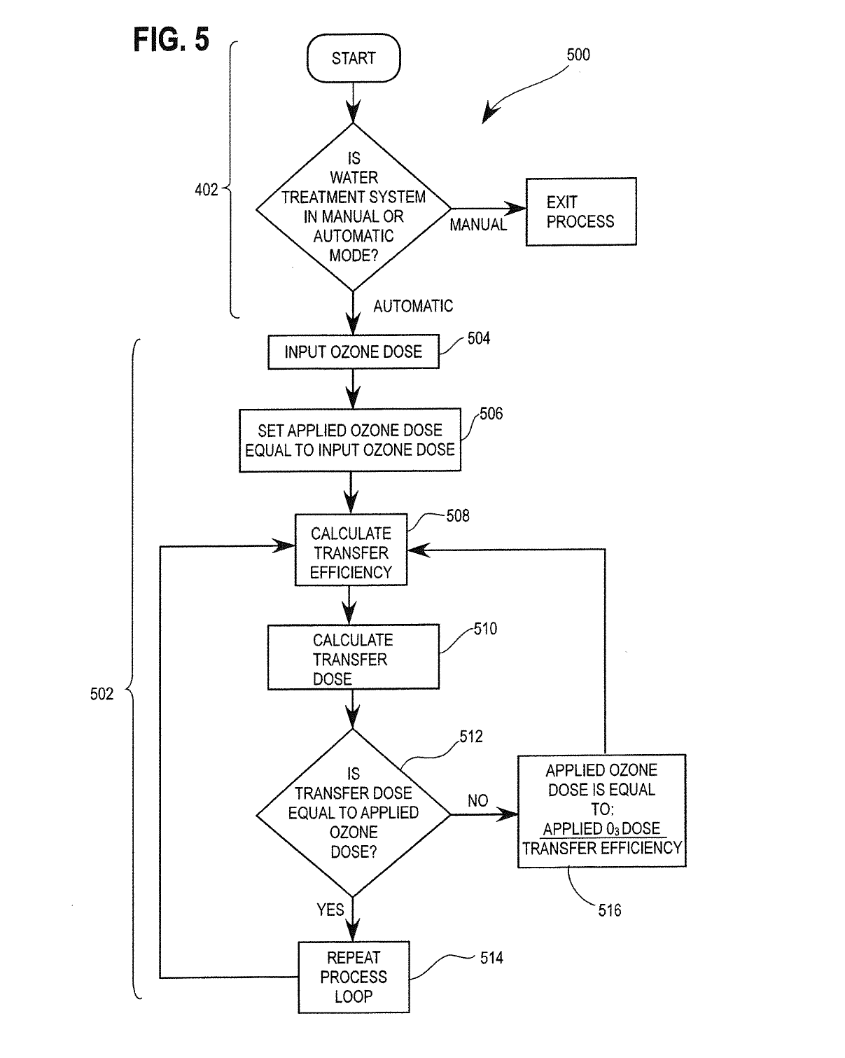

The flow controller 122 measures the gas flow rate in the ozone gas source 106 and transfers the real-time data to the programmable logic controller (PLC) 130. The gas flow rate measured by the flow controller 122 is used in the transfer efficiency process control 500 to determine the ozone dosage, as described below in FIG. 5. In some embodiments, the flow controller 122 may be used to regulate gas flow, as described below in FIG. 3.

The ozone sensor 124 measures the amount of ozone generated by the ozone gas source 106 and transfers the real-time data to the programmable logic controller (PLC) 130. The amount of ozone as measured by the ozone sensor 124 is used by the transfer efficiency process control 500 to determine the ozone dosage, as described below in FIG. 5.

Once the ozone gas has been transferred into the water, the resulting ozone-saturated water stream flows from the gas injector 108 through the ozone-saturated water conduit 110, and then into the mixer/separator phase 112. The ozone-saturated water flow rate sensor 126 measures the flow rate of the ozone-saturated water stream flowing through the ozone-saturated water conduit 110. The ozone-saturated water stream flow rate is used by the transfer efficiency process control 500 to determine the ozone dosage, as described below in FIG. 5.

During the mixer/separator phase 112 the ozone gas is further dissolved into the water stream, and any remaining undissolved ozone gas is separated from the water stream and diverted to the ozone destructor 116. A greater percentage of dissolved ozone gas results in greater effectiveness of the ozone water treatment.

The diverted excess ozone gas enters the excess ozone gas conduit 114. The excess ozone gas sensor 128 measures the amount of ozone gas in the excess ozone gas conduit 114. The amount of ozone in the excess ozone gas conduit 114 is used by the transfer efficiency process control 500 to determine the ozone dosage, as described below in FIG. 5. The excess ozone gas conduit 114 then flows into the ozone destructor 116, where the excess ozone is destroyed before releasing the gas into the atmosphere.

The water stream is discharged from the mixer/separator phase 112 and enters the contact chamber 118. The contact chamber 118 provides additional contact time for the dissolved ozone to oxidize and eliminate the remaining contaminants and pathogens in the water. The fully treated effluent water stream 120 then exits the contact chamber 118.

Referring next to FIG. 2, a diagram of an ozone water treatment system 200 in accordance with another embodiment of the present invention is shown. Shown are the influent water source 102, the booster pump 104, an optional sump pump 202, a variable frequency drive 204, the programmable logic controller (PLC) 130, an influent water conduit 206, a plurality of optional influent water sensors 208, the gas injector 108, the ozone gas source 106, an ozone-saturated water conduit 110, an ozone-saturated water flow rate sensor 126, a plurality of optional ozone-saturated water sensors 210, a mixer 212, a separator 214, the excess ozone gas conduit 114, the ozone destructor 116, the excess ozone gas sensor 128, a post-separator water conduit 216, a plurality of optional post-separator water sensors 218, the contact chamber 118, a plurality of contact chamber sensors 220, and the effluent water stream 120.

The influent water source 102 may be comprised of any water source requiring treatment for disinfection, contamination, odor, or any other effect provided by ozone treatment. Examples of influent water sources 102 for ozone water treatment include wastewater with prior primary and secondary treatments and drinking water. The influent water source 102 is fluidly coupled to the intake of the booster pump 104, for example, by an intake conduit or pipe. The booster pump 104 is coupled to the variable frequency drive 204. The variable frequency drive 204 is in communication with and is regulated by the programmable logic controller (PLC) 130. The programmable logic controller 130 typically comprises hardware and software as required to receive and analyze data and to regulate the ozone water treatment system 100 based on input by the user. The variable frequency drive 204 is connected to the programmable logic controller 130 using wires, wireless signals, or other method of transferring data. The discharge of the booster pump 104 is fluidly coupled to the upstream end of the influent water conduit 206. The influent water conduit 206 is of size and composition as required by the influent water source 102 properties, flow rate and water volume.

In some configurations of the present invention, various embodiments include the optional sump pump 202 located between the influent water source 102 and the booster pump 104. The intake of the optional sump pump 202 is fluidly coupled to the influent water source 102 and the discharge of the optional sump pump 202 is fluidly coupled to the booster pump 104.

The plurality of optional influent water sensors 208 are in fluid communication with the influent water flowing through the influent water conduit 206. Examples of optional influent water sensors 208 include, but are not limited to, pressure, temperature, flow rate, pH, oxidation-reduction optional (ORP), ultra-violet transmittance (UVT), and total organic carbon (TOC). The optional influent water sensors 208 transfer data to the programmable logic controller (PLC) 130 using wires, wireless signals, or other method of transferring data. In an alternate embodiment of the invention, the plurality of optional influent water sensors 208 are in fluid communication with the influent water source 102.

The downstream end of the influent water conduit 206 is fluidly coupled, for example by a pipe or other conduit, to the water intake of the gas injector 108. The gas intake of the gas injector 108 is also fluidly coupled, for example by a pipe or other conduit, to the ozone gas source 106 of the ozone water treatment system 100. The ozone gas source 106 of the ozone water treatment system 100 is described below in FIG. 3. In the present embodiment of the invention, the gas injector 108 is a venturi injector. Alternate gas transfer devices include diffuser-type transfer devices.

The discharge of the gas injector 108 is fluidly coupled to the upstream end of the ozone-saturated water conduit 110. The ozone-saturated water conduit 110 is of size and composition as required by the ozone-saturated water stream properties, flow rate and water volume. The ozone-saturated water flow rate sensor 126 is in fluid communication with the ozone-saturated water stream flowing through the ozone-saturated water conduit 110. The plurality of optional ozone-saturated water sensors 210 are in fluid communication with the ozone-saturated water stream flowing through the ozone-saturated water conduit 110. Examples of optional ozone-saturated water sensors 210 include, but are not limited to, pressure, temperature, flow rate, pH, oxidation-reduction potential (ORP), ultra-violet transmittance (UVT) and total organic carbon (TOC). The ozone-saturated water flow rate sensor 126 and the plurality of optional ozone-saturated water sensors 210 transfer data to the programmable logic controller (PLC) 130 using wires, wireless signals, or other method of transferring data.

The downstream end of the ozone-saturated water conduit 110 is coupled to the intake of the mixer 212. In the present embodiment of the invention, the mixer 212 is a flash reactor. The discharge of the mixer 212 is fluidly coupled to the intake of the separator 214, for example, by a pipe or other conduit. In the present embodiment of the invention, the separator 214 is a centrifugal degas separator. The ozone gas discharge of the separator 214 is fluidly coupled, for example by a pipe or other conduit, to the upstream end of the excess ozone gas conduit 114. The excess ozone gas conduit 114 is of size and composition as required by the excess ozone gas properties, flow rate and gas volume. The water discharge of the separator 214 is fluidly coupled, for example by a pipe or other conduit, to the post-separator water conduit 216. The excess ozone gas sensor 128 is in fluid communication with the excess ozone gas stream flowing through the excess ozone gas conduit 114. The excess ozone gas sensor 128 transfers data to the programmable logic controller (PLC) 130 using wires, wireless signals, or other method of transferring data.

The downstream end of the excess ozone gas conduit 114 is fluidly coupled, for example by a pipe or other conduit, to the intake of the ozone destructor 116. The discharge of the ozone destructor 116 discharges to the ambient air.

The downstream end of the post-separator water conduit 216 is coupled to the intake of the contact chamber 118. The plurality of optional post-separator water sensors 218 are in fluid communication with the water flowing through the post-separator water conduit 216. Some examples of optional post-separator water sensors 218 include, but are not limited to, pressure, temperature, flow rate, pH, oxidation-reduction potential (ORP), ultra-violet transmittance (UVT), and total organic carbon (TOC). The plurality of optional post-separator water sensors 218 transfer data to the programmable logic controller (PLC) 130 using wires, wireless signals, or other method of transferring data.

The contact chamber 118 is of size, shape and configuration as required by the influent water quality, desired treatment level and site conditions. The contact chamber 118 of the present embodiment of the present invention is a serpentine type chamber. The plurality of optional contact chamber sensors 220 are in fluid communication with the water in the contact chamber 118, and are of number and type to record the required properties of the post-separator water stream. Some examples of optional contact chamber sensors 220 include, but are not limited to, pressure, temperature, flow rate, pH, oxidation-reduction potential (ORP), ultra-violet transmittance (UVT), and total organic carbon (TOC). In an alternate embodiment of the invention, contact chamber sensors 220 of the same type are placed in multiple locations in the contact chamber 118. The optional contact chamber sensors 220 transfer data to the programmable logic controller (PLC) 130 using wires, wireless signals, or other method of transferring data. The fully treated effluent water stream 120 exits the discharge of the contact chamber 118.

Referring again to FIG. 2, the influent water source 102 is pumped through the booster pump 104 in order to control the influent water stream flow rate. The variable frequency drive 204 regulates the speed of the booster pump 104 and thus controls the rate of flow of the influent water source 102. The skilled artisan will recognize that additional pumps 104 may be added to the ozone water treatment system 100 as needed to provide the required system water flow rate. The optional sump pump 202 is located upstream of the booster pump 104 as required by the flow rate and location of the influent water source 102 with respect to the ozone water treatment system 100. The influent water source 102 exits the booster pump 104 and flows into the upstream end of the influent water conduit 206. The plurality of optional influent water sensors 208 in fluid communication with the influent water source 102 flowing through the influent water conduit 206 transmit data to the programmable logic controller (PLC) 130. The plurality of optional influent water sensors 208 are discretionary and are of number and type as required to record properties of the influent water source 102. Examples of optional influent water sensors 208 include, but are not limited to, pressure, temperature, flow rate, pH, oxidation-reduction optional (ORP), ultra-violet transmittance (UVT), and total organic carbon (TOC). ORP, UVT and TOC are water measurements that are used to determine the amount of pathogens and contaminants in the influent water source 102. Examples of usage of data provided by the optional influent water sensors 208 are record-keeping, analysis of water treatment efficiency and real-time monitoring and control of the ozone water treatment system 100.

The influent water source 102 flows though the influent water conduit 206 and is discharged into the water intake of the gas injector 108. The ozone gas source 106, described below in FIG. 3, discharges ozone gas into the gas intake of the gas injector 108. As the influent water and ozone gas enter the gas injector 108, the gas injector 108 transfers the ozone gas into the influent water source 102. The ozone gas dissolved into the influent water source 102 is then available to chemically react with and eliminate contaminants and pathogens in the water.

Once the ozone gas has been transferred into the influent water source 102, the resulting ozone-saturated water stream flows from the gas injector through the ozone-saturated water conduit 110, and into the mixer 212. The ozone-saturated water flow rate sensor 126 measures the flow rate of the ozone-saturated water stream flowing through the ozone-saturated water conduit 110. In one embodiment of the invention, the ozone-saturated water stream flow rate is used by the transfer efficiency process control 500 to determine the ozone dosage, as described below in FIG. 5. A plurality of optional ozone-saturated water sensors 210, in fluid communication with the ozone-saturated water stream, are discretionary and are of number and type as required to measure properties of the ozone-saturated water stream flowing through the ozone-saturated water conduit 110. Some examples of optional ozone-saturated water sensors 210 include, but are not limited to, pressure, temperature, flow rate, pH, oxidation-reduction potential (ORP), ultra-violet transmittance (UVT) and total organic carbon (TOC). Examples of usage of data provided by the optional ozone-saturated water sensors 210 are record-keeping, analysis of water treatment efficiency and real-time monitoring and control of the ozone water treatment system 100. The mixer 212 aids in the dissolving of the ozone gas into the water stream, as a greater percentage of dissolved ozone gas results in greater effectiveness of the ozone treatment.

After exiting the mixer 212, the ozone-saturated water stream enters the separator 214. The separator 214 removes any remaining non-dissolved ozone gas and diverts it to the excess ozone gas conduit 114. The excess ozone gas sensor 128 measures the amount of ozone gas in the excess ozone gas stream flowing through the excess ozone gas conduit 114. In one embodiment of the invention, the amount of ozone gas in the excess ozone gas stream is used by the transfer efficiency process control 500 to determine the ozone dosage, as described below in FIG. 5. The excess ozone gas stream in the excess ozone gas conduit 114 then flows into the ozone destructor 116, where the excess ozone is destroyed before releasing the gas into the atmosphere.

The separator 214 discharges the post-separator water stream into the post-separator water conduit 216. The plurality of optional post-separator water sensors 218 are in fluid communication with the post-separator water stream. The plurality of optional post-separator water sensors 218 are discretionary and are of number and type as required to record properties of the post-separator water stream flowing through the post-separator water conduit 216. Some examples of the optional post-separator water sensors 218 include, but are not limited to, pressure, temperature, flow rate, pH, oxidation-reduction potential (ORP), ultra-violet transmittance (UVT), and total organic carbon (TOC). Examples of usage of data provided by the optional post-separator water sensors 218 are record-keeping, analysis of water treatment efficiency and real-time monitoring and control of the ozone water treatment system 100.

The post-separator water stream flows through the post-separator water conduit 216 and into the contact chamber 118. The contact chamber 118 provides additional contact time for the dissolved ozone to oxidize and eliminate the remaining contaminants and pathogens in the water. The plurality of optional contact chamber sensors 220 are discretionary and are of number and type to record the required properties of the post-separator water stream flowing through the post-separator water conduit 216. Some examples of optional contact chamber sensors 220 include, but are not limited to, pressure, temperature, flow rate, pH, oxidation-reduction potential (ORP), ultra-violet transmittance (UVT), and total organic carbon (TOC). Contact chamber sensors 220 of the same type may also be placed in multiple locations in the contact chamber 118 in order to record water properties for differing amounts of contact time. Examples of usage of data provided by the optional contact chamber sensors 220 are record-keeping, analysis of water treatment efficiency and real-time monitoring and control of the ozone water treatment system 100.

The fully treated effluent water stream 120 is then discharged from the contact chamber 118 into the general water system, for additional treatment, or into the environment.

Referring next to FIG. 3, an ozone gas source 106 in one embodiment of the present invention is shown. The ozone gas source 106 comprises an air compressor 300, an compressed air pressure sensor 302, an air conduit 304, an oxygen concentrator 306, an oxygen storage device (also referred to as an oxygen tank) 308, an oxygen conduit 310, an oxygen pressure sensor 312, a dissolved oxygen conduit 314, a dissolved oxygen valve 316, a dissolved oxygen sensor 318, a flow controller 122, a pre-generator valve 320, an ozone generator 322, an ozone conduit 324, a post-generator valve 326, a pressure switch 328, an ozone sensor 124, a liquid trap 330, a level switch 332, an actuated ball valve 334, and an ozone pressure sensor 336.

The discharge of the air compressor 300 is fluidly coupled to the upstream end of the air conduit 304. The air conduit 304 is of size and composition as required by the system requirements of the ozone water treatment system 100. The downstream end of the air conduit 304 is fluidly coupled to the intake of the oxygen concentrator 306. The compressed air pressure sensor 302 is in fluid communication with the air flowing through the air conduit 304. The compressed air pressure sensor 302 transfers data to the programmable logic controller (PLC) 130 using wires, wireless signals, or other method of transferring data. The discharge of the oxygen concentrator 306 is fluidly coupled to the intake of the oxygen storage device 308, for example, by a pipe or other conduit.

The discharge of the oxygen storage device 308 is fluidly coupled to the upstream end of the oxygen conduit 310. The oxygen conduit 310 is of size and composition as required by the system requirements of the ozone water treatment system 100. The oxygen pressure sensor 312 is in fluid communication with the gas flowing through the oxygen conduit 310, and is proximate to the upstream end of the oxygen conduit 310.

The dissolved oxygen conduit 314 is located downstream of, and proximate to, the oxygen pressure sensor 312. The dissolved oxygen conduit 314 is fluidly coupled to, and branches off from, the oxygen conduit 310. The dissolved oxygen conduit 314 is of size and composition as required by the system requirements of the ozone water treatment system 100. The downstream end of the dissolved oxygen conduit 314 is open to the atmosphere. The dissolved oxygen valve 316 is integral with the dissolved oxygen conduit 314.

The flow controller 122 is located downstream of and proximate to the dissolved oxygen conduit 314, and is in fluid communication with the gas flowing through the oxygen conduit 310. The pre-generator valve 320 is integral with the oxygen conduit 310 and is located between the flow controller 122 and the downstream end of the oxygen conduit 310. The oxygen pressure sensor 312, the dissolved oxygen sensor 318 and the flow controller 122 transfer data to the programmable logic controller (PLC) 130. The dissolved oxygen sensor 318 and the pre-generator valve 320 are in communication with and are regulated by the programmable logic controller 130. The sensors 122, 312, 318 and valves 316, 320 are in communication with the programmable logic controller 130 using wires, wireless signals, or other method of transferring data.

The downstream end of the oxygen conduit 310 is fluidly coupled to the intake of the ozone generator 322. The ozone generator 322 is of size and type as required by the amount of ozone required for water treatment and by site conditions. In some configurations, as required by the volume and quality of the influent water source, a plurality of ozone generators 322 in parallel, with conduits, valves, and sensors as required, may be used.

The discharge of the ozone generator 322 is fluidly coupled to the upstream end of the ozone conduit 324. The ozone conduit 324 is of size and composition as required for water treatment and by site conditions. The post-generator valve 326 is integral with the ozone conduit 324 and is located proximate to the upstream end of the ozone conduit 324. The post-generator valve 326 is in communication with and is regulated by the programmable logic controller (PLC) 130. The post-generator valve 326 is controlled by the programmable logic controller 130 using wires, wireless signals, or other method of transferring data.

The pressure switch 328 is downstream of and proximate to the post-generator valve 326, and is in fluid communication with the gas flowing through the ozone conduit 324. The pressure switch 328 transfers data to the programmable logic controller (PLC) 130 using wires, wireless signals, or other method of transferring data.

The ozone sensor 124 is located downstream of and proximate to the pressure switch 328, and is in fluid communication with the gas flowing through the ozone conduit 324. The ozone sensor 124 transfers data to the programmable logic controller (PLC) 130 using wires, wireless signals, or other method of transferring data.

The liquid trap 330 is located downstream from and proximate to the ozone sensor 124, and is integral with the ozone conduit 324. The level switch 332 is in fluid communication with the liquid trap 330 and transfers data to the programmable logic controller (PLC) 130 using wires, wireless signals, or other method of transferring data.

The actuated ball valve 334 is located downstream of and proximate to the liquid trap 330, and is integral with the ozone conduit 324. The actuated ball valve 334 is in communication with and is regulated by the programmable logic controller (PLC) 130. The actuated ball valve 334 receives instruction from the programmable logic controller 130 using wires, wireless signals, or other method of transferring data. The ozone pressure sensor 336 is located downstream of and proximate to the actuated ball valve 334, and is in fluid communication with the gas flowing through the ozone conduit 324. The ozone pressure sensor 336 transfers data to the programmable logic controller (PLC) 130 using wires, wireless signals, or other method of transferring data. The downstream end of the ozone conduit 324 is fluidly coupled to the gas intake of the gas injector 108, as previously shown in FIGS. 1 and 2.

Referring again to FIG. 3, the air compressor 300 intakes ambient air and discharges pressurized air into the air conduit 304. The compressed air pressure sensor 302 measures the pressure in the air conduit 304 in order to monitor and control the air flow.

The compressed air flows into the oxygen concentrator 306, where the oxygen is separated from the air. The oxygen is transferred from the oxygen concentrator 306 to the oxygen storage device 308, and the remainder of the air is released from the oxygen concentrator 306 into the atmosphere. The oxygen storage device 308 discharges the oxygen into the oxygen conduit 310. The oxygen pressure sensor 312 measures the pressure in the oxygen conduit 310 in order to monitor and control the gas flow into the ozone generator 322.

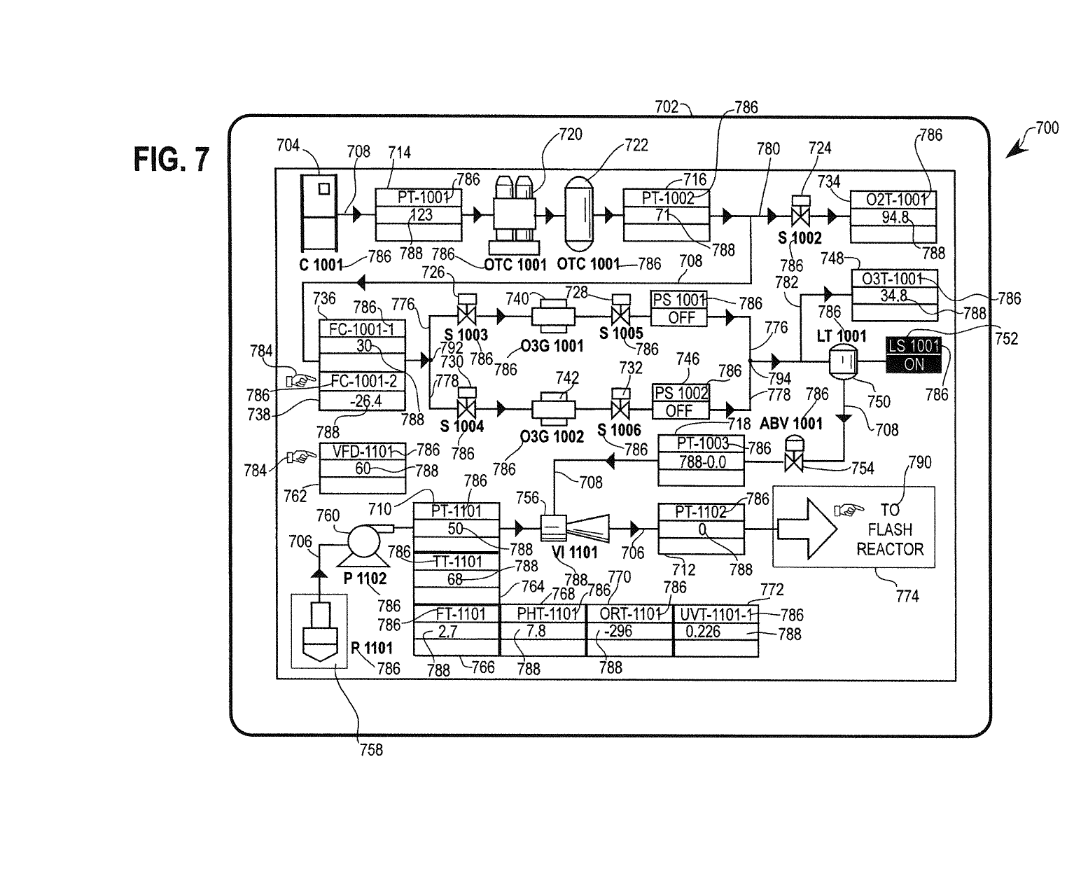

Downstream of the oxygen pressure sensor 312, the dissolved oxygen valve conduit 314 branches from the oxygen conduit 310 and terminates at the dissolved oxygen sensor 318, which measures the amount of dissolved oxygen in the gas. An amount of dissolved oxygen measured by the dissolved oxygen sensor 318 is communicated to the PLC, as shown further below in the first display panel 702 of FIG. 7. Measurements of the dissolved oxygen sensor 318 may also be used by the PLC 130 in system regulation algorithms. The dissolved oxygen valve 316 is controlled by the PLC 130 to regulate the flow of gas to the dissolved oxygen valve 316.

The flow controller 122 measures the flow rate of the oxygen gas flowing through the oxygen conduit 310. If the flow rate of the oxygen gas flowing through the oxygen conduit 310 is too high, the pre-generator valve 320 upstream of and proximate to the ozone generator 322 is directed by the programmable logic controller 130 to switch to the off position. In one embodiment of the present invention, the ozone flow rate measured by the flow controller 122 is used in the transfer efficiency control process 500 to determine the ozone dosage, as described below in FIG. 5. The pre-generator valve 320 also prevents backflow into the oxygen storage device 308.

The oxygen gas then flows from the oxygen conduit 310 into the ozone generator 322. The ozone generator 322 converts the oxygen (O₂) into ozone (O₃) using electrical current.

The ozone gas exits the ozone generator 322 into the ozone conduit 324. A post-generator valve 326 proximate to the upstream end of the ozone conduit 324 controls the ozone flow and prevents backflow. The pressure switch 328 located downstream of and proximate to the post-generator valve 326 measures the gas pressure and transfers the real-time data to the programmable logic controller 130. If the gas pressure is above a specific value set by the user, the programmable logic controller 130 closes the post-generator valve 326.

Downstream of and proximate to the pressure switch 328, the ozone sensor 124 measures the amount of ozone in the ozone conduit 324 and transfers the real-time data to the programmable logic controller 130. In one embodiment of the invention, the amount of ozone as measured by the ozone sensor 124 is used by the transfer efficiency process control 500 to determine the ozone dosage, as described below in FIG. 5. Next, the ozone gas stream in the ozone conduit 324 passes through the liquid trap 330. The liquid trap 330 filters out any liquid in the ozone gas stream. The level switch 332 checks for liquid in the liquid trap 330 and the programmable logic controller 130 shuts off the ozone generator 322 if liquid is found in the liquid trap 330.

Downstream of and proximate to the liquid trap 330, the ozone gas flows through the actuated ball valve 334. The ozone pressure sensor 336 downstream of the actuated ball valve 334 measures the pressure of the ozone gas flowing through the ozone conduit 324 and transfers the data to the programmable logic controller (PLC) 130. If the gas pressure is above a specific value set by the user, the programmable logic controller 130 closes the actuated ball valve 334. The ozone gas then flows from the ozone conduit 324 into the gas intake of the gas injector 108, as previously described in FIGS. 1 and 2.

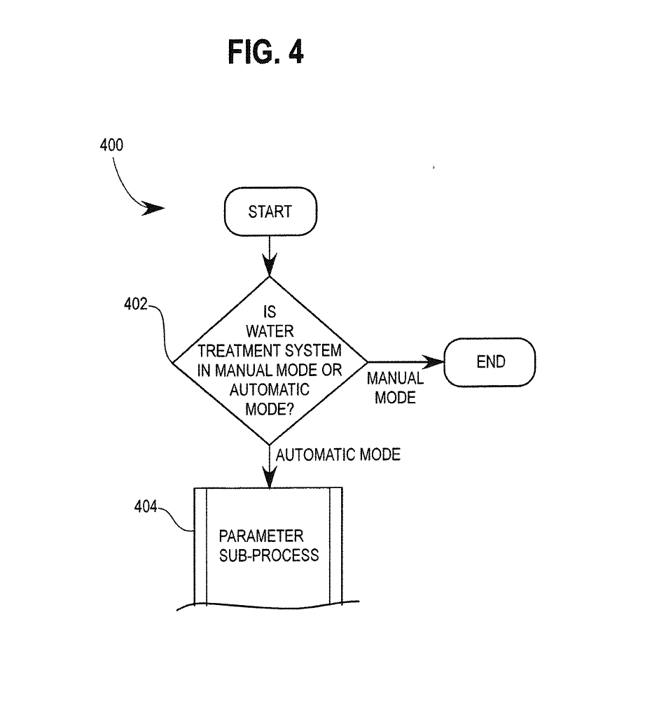

Referring next to FIG. 4, in accordance with one aspect of the teachings presented herein, an exemplary process control 400 flow diagram is presented. Shown are an automatic/manual step 402, and a parameter sub-process step 404.

The process control 400 is directed by a program implemented on the programmable logic controller (PLC) 130 (shown in FIGS. 1, 2 and 3). In one embodiment, a software package may be used in conjunction with the programmable logic controller (PLC) 130 to implement the exemplary process control 400 and any additional process controls. Process controls are defined to be algorithms programmed into the programmable logic controller 130 to control and/or regulate the ozone water treatment system 100.

First, the automatic/manual step 402 determines if the ozone water treatment system 100 (shown in FIG. 1) is being run in manual or automatic mode. If the user input indicates that the ozone water treatment system 100 is in manual mode, the process control 400 exits and no modifications are made to the ozone water treatment system 100. If instead the user input indicates that the ozone water treatment system 100 is in automatic mode, the process control 400 proceeds to the second step.

The second step in the process control 400 is the parameter sub-process step 404. The parameter sub-process, such as an exemplary transfer efficiency sub-process 502 shown below in FIG. 5, is a loop process that utilizes sensor data and user-input parameters to continually regulate a specific aspect of the ozone water treatment system 100 in real-time. Examples of parameter sub-process steps 404 include a SUVA reduction sub-process, an ORP sub-process and a dissolved ozone sub-process. ORP reduction, TOC reduction and specific ultra-violet absorption (SUVA) reduction are all indicators of either a reduction in pathogens, contaminants, or both.

Referring next to FIG. 5, in accordance with one aspect of the teachings presented herein, an exemplary transfer efficiency process control 500 flow diagram is presented. Shown are the automatic/manual step 402, the transfer efficiency sub-process 502, an input ozone dose step 504, a set applied ozone dose step 506, a transfer efficiency calculation step 508, a transfer dose calculation step 510, a transfer dose decision point step 512, a repeat process loop step 514, and an applied dose regulation step 516.

The transfer efficiency process control 500 is directed by a program implemented on the programmable logic controller (PLC) 130 (shown in FIGS. 1, 2 and 3). In one embodiment, a software package may be used in conjunction with the programmable logic controller (PLC) 130 to implement the transfer efficiency process 500 and any additional control process. Control processes, for example the transfer efficiency process control 500, are defined to be algorithms programmed into the programmable logic controller 130 to control and/or regulate the ozone water treatment system 100.

First, the automatic/manual step 402 determines if the ozone water treatment system 100, as previously described in FIG. 4 is being run in manual or automatic mode. If the user input indicates that the ozone water treatment system 100 is in manual mode, the transfer efficiency process control 500 exits and no modifications are made to the ozone water treatment system 100. If instead the user input indicates that the ozone water treatment system 100 is in automatic mode, the transfer efficiency process control 500 proceeds to the transfer efficiency sub-process 502.

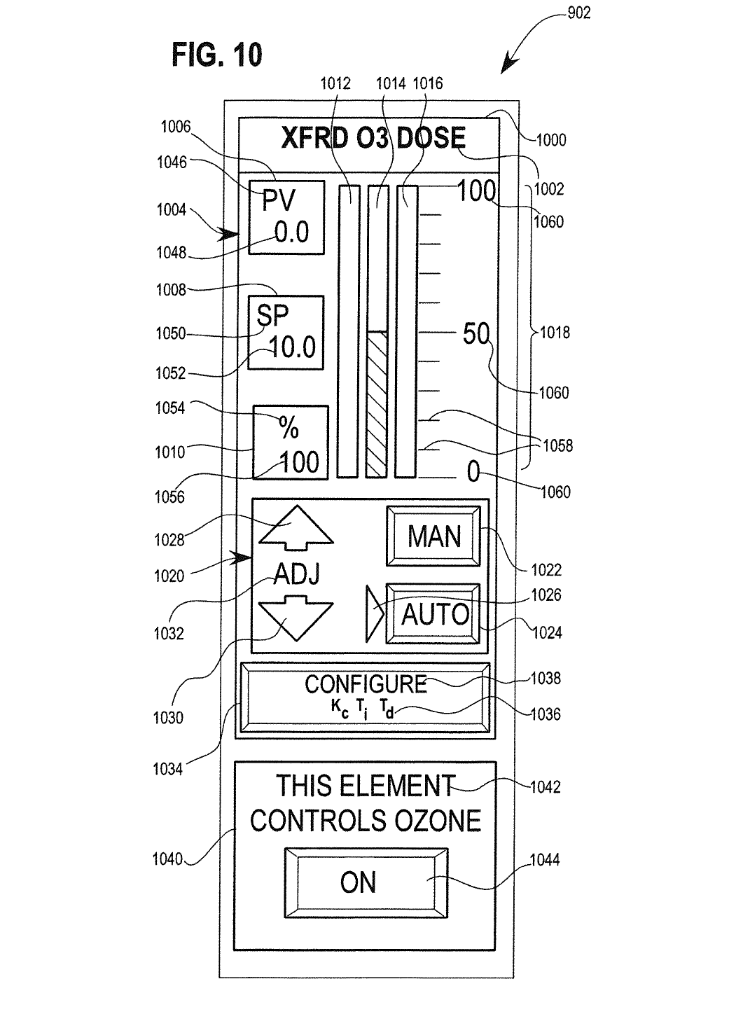

In the present embodiment of the invention, the transfer efficiency sub-process 502 is comprised of seven steps: The first step in the transfer efficiency sub-process 502 is the input ozone dose step 504. During the input ozone dose step 504, the user inputs a value for the input ozone dose. The input ozone dose, in mass of ozone per volume of water, is dependent on the water quality and the desired level of water treatment. Determination of the input ozone dose based on water source quality and disinfection or decontamination criteria is described in more detail below in FIG. 10. The transfer efficiency sub-process 502 then proceeds to step two.

The second step in the transfer efficiency sub-process 502 is the applied ozone dose step 506. The applied ozone dose step 506 sets the applied ozone dose, in mass of ozone per volume of water, as equal to the input ozone dose input by the user during the previous input ozone dose step 504. The programmable logic controller (PLC) 130 adjusts the rate of ozone gas production and ozone gas flow rate as required to provide the applied ozone dose to the ozone water treatment system 100. The transfer efficiency sub-process 502 then proceeds to step three.

The third step in the transfer efficiency sub-process 502 is the transfer efficiency calculation step 508. The transfer efficiency calculation step 508 uses the measurements taken by the ozone sensor 124 and the excess ozone gas sensor 128 to calculate the amount of ozone gas not dissolved into the ozone-saturated water stream flowing through the ozone-saturated water conduit 110. The transfer efficiency is defined as the difference between the measurement of the ozone sensor 124 and measurement of the excess ozone gas sensor 128, divided by the measurement of the ozone sensor 124. The transfer efficiency indicates the percentage of ozone gas dissolved into the water stream. A transfer efficiency of 1.0 indicates that all ozone gas has been dissolved into the water stream and the amount of excess ozone gas is zero. A transfer efficiency of zero indicates that no ozone gas has been dissolved into the water stream. The transfer efficiency sub-process 502 then proceeds to step four.

The fourth step in the transfer efficiency sub-process 502 is the transfer dose calculation step 510. The transfer dose calculation step 510 calculates the transfer dose. The transfer dose is calculated as the previously set applied ozone dose multiplied by the result of the transfer efficiency calculated in the previous transfer efficiency calculation step 508. The transfer efficiency sub-process 502 then proceeds to step five.

The fifth step in the transfer efficiency sub-process 502 is the transfer dose decision point step 512. In the transfer dose decision point step 512, the transfer dose calculated during the transfer dose calculation step 510 is compared to the previously set applied ozone dose. If the transfer dose is equal to the applied ozone dose, the transfer efficiency sub-process 502 proceeds to the repeat process loop step 514. If the transfer dose is less than the applied ozone dose, the transfer efficiency sub-process 502 proceeds to the applied dose regulation step 516.

The repeat process loop step 514 returns the transfer efficiency sub-process 502 to the transfer efficiency calculation step 508.

The applied dose regulation step 516 modifies the applied ozone dose by multiplying the previously sat applied ozone dose (either calculated in the applied ozone dose step 506 or by the prior applied dose regulation step 516) by the transfer efficiency calculated in the previous transfer efficiency calculation step 508. The programmable logic controller (PLC) 130 adjusts the rate of ozone gas production and ozone gas flow rate as required to provide the adjusted applied ozone dose to the ozone water treatment system 100. The transfer efficiency sub-process 502 then returns to the transfer efficiency calculation step 508.

The transfer efficiency process control 500 provides a constant amount of dissolved ozone in the ozone water treatment system 100. The skilled artisan will recognize that the exemplary transfer efficiency process control 500 contains only a proportional component to determine the ozone dose, but may be modified to include additional process components, such as a time-dependent (integral) component and a rate-of-change (derivative) component.

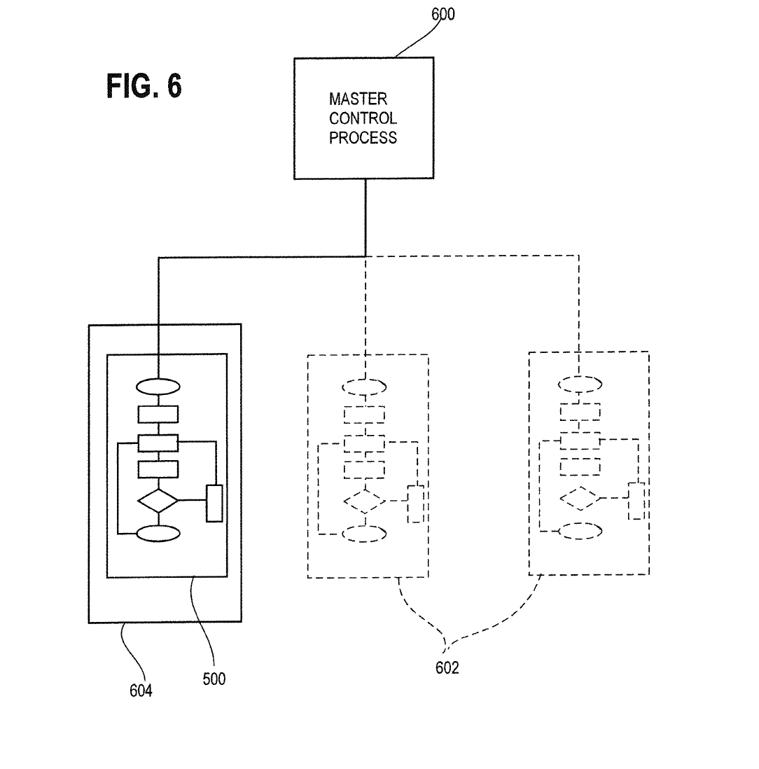

Referring next to FIG. 6, one embodiment of the present invention shows a master process control 600, the transfer efficiency process control 500, a plurality of optional process controls 602 and a current process control 604.

The optional process controls 602 may be added to control additional effluent water properties such as ORP reduction, TOC reduction or specific ultra-violet absorption (SUVA) reduction, all indicators of either a reduction in pathogens, contaminants, or both. The programmable logic controller (PLC) 130 (shown in FIGS. 1,2 and 3) controls both the process controls 500, 602 and the master process control 600. The master process control 600 monitors the transfer efficiency process control 500 and the optional process controls 602 for differentials between input target values and actual values. The master process control 600 then compares the differentials and sets the current process control 604 based on the user-input criteria. An exemplary master control algorithm would set the current process control 604 as the process control with the highest differential. In the embodiment shown in FIG. 6, the current process control 604 is shown to be the transfer efficiency process control 500. The master process control 600 continuously monitors the process controls 500, 602 and changes the current process control 604 as necessary based on the master control algorithm.

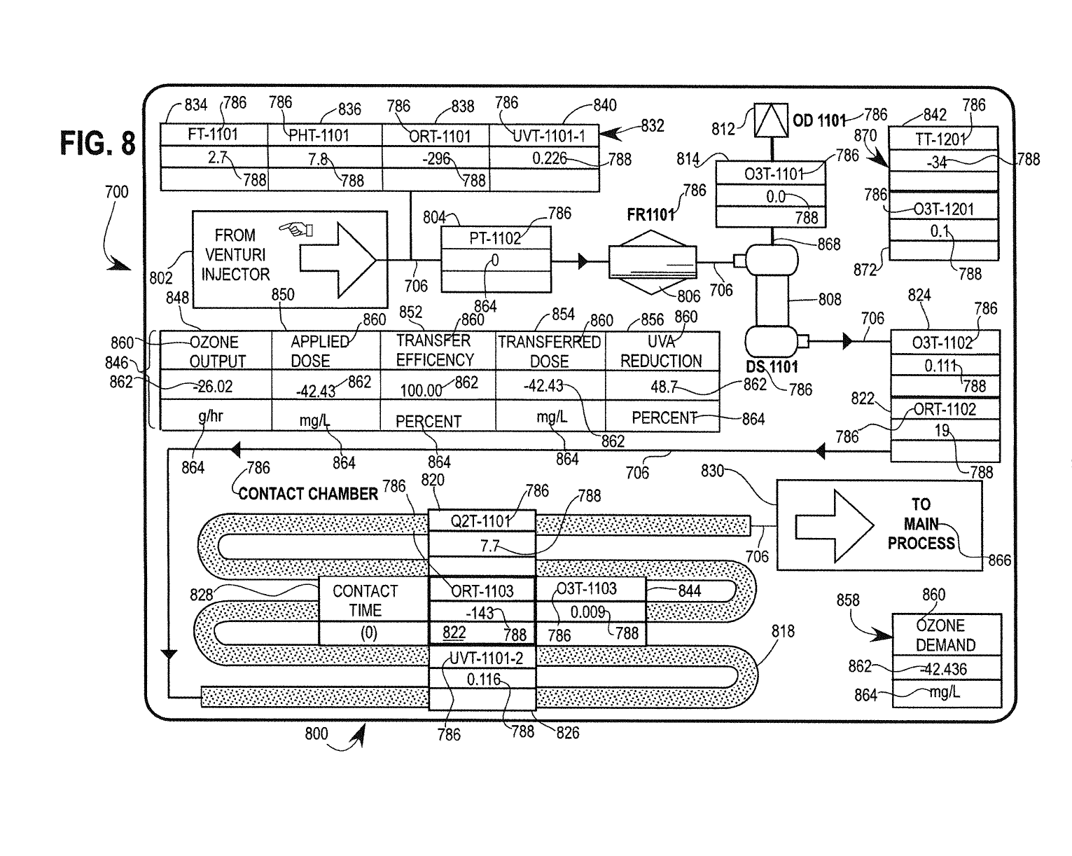

Referring next to FIGS. 7 and 8, an exemplary water treatment system display 700 for the ozone water treatment system 100 is shown. In the exemplary display 700, the display of the ozone water treatment system 100 has been split between two display panels, the first display panel 702 as shown in FIG. 7, and the second display panel 800 as shown in FIG. 8. Those skilled in the art will recognize that the preferred number of display panels is dependent on various factors, for example the complexity of the ozone water treatment system 100 and the size of the display panel. The preferred embodiment of the invention may include a single display panel, or may include two or more display panels. The skilled artisan will also note that the water treatment system display 700 is diagrammatic and is not meant to convey the actual size and scale of the ozone water treatment system 100, but instead to show the relative location and relationships between the components, sensors and monitors.

The ozone water treatment system 100 is by nature a linear system, with an influent water source 102 entering and proceeding linearly through the water treatment process until the effluent water stream 120 exits the ozone water treatment system 100. Correspondingly, the water treatment system display 700 may be shown in a single horizontal line, although doing so with the exemplary ozone water treatment system 100 would result in the line diagram being split over several display panels, making it difficult for the user to understand the ozone water treatment system 100 as a whole. Thus, portions of the exemplary water treatment system display 700 are arranged in a serpentine manner on the display screen in order to convey the maximum amount of information on the screen. The skilled artisan will note that the line diagram may be arranged in any suitable configuration on the display screen as long as the relationships between the components, sensors and monitors remain intact.

The display panels 702 800 include icons that correspond to components of the ozone water treatment system 100, display boxes that correspond to sensors and monitors, and connecting lines and arrows that correspond to the line of fluid flow of the ozone water treatment system 100, hereinafter referred to as the “flow line.” In the present embodiment of the invention, the display panels 702 800 are rectangular with a landscape orientation. The icons and other graphics displayed on the display panels 702 800 may be created using a graphics program, for example, Adobe Illustrator, or may be imported from a graphics library included in operator interface configuration software, for example Crimson by Red Lion. The icons corresponding to components of the ozone water treatment system 100 are displayed as either a simplified graphical representation of the component or the conventional mechanical engineering symbol for the component.

Referring next to FIG. 7, the first display panel 702 of the water treatment system display 700 is shown. Shown are a compressor icon 704, a main flow line 706, a gas flow line 708, a first pressure sensor display 710, a second pressure sensor display 712, a third pressure sensor display 714, a fourth pressure sensor display 716, a fifth pressure sensor display 718, an oxygen concentrator icon 720, an oxygen tank icon 722, a first solenoid valve icon 724, a second solenoid valve icon 726, a third solenoid valve icon 728, a fourth solenoid valve icon 730, a fifth solenoid valve icon 732, an oxygen sensor display 734, a first flow controller display 736, a second flow controller display 738, a first ozone generator icon 740, a second ozone generator icon 742, a first pressure switch display 744, a second pressure switch display 746, a first ozone sensor display 748, a liquid trap icon 750, a level switch display 752, an actuated ball valve icon 754, a gas injector icon 756, a sump pump icon 758, a booster pump icon 760, a variable frequency drive display 762, a first temperature sensor display 764, a flow sensor display 766, a pH sensor display 768, a first ORP sensor display 770, a first UVA sensor display 772, a first continuation display 774, a first ozone generation flow line 776, a second ozone generation flow line 778, a secondary oxygen flow line 780, a secondary ozone flow line 782, a plurality of pointer icons 784, a plurality of text labels 786, a plurality of real-time monitor values 788, a first continuation text 790, an ozone generation branch point 792, and an ozone generation convergence point 794.

The first display panel 702 includes two primary flow lines: the main flow line 706, which starts with the influent water and continues linearly through the water treatment process until the effluent water exits the water treatment process, and the gas flow line 708, which starts at the compressor icon 704 and continues linearly until it terminates at the gas injector icon 756. The main flow line 706 corresponds to the ozone water treatment system 100 shown in FIGS. 1 and 2. The gas flow line 708 corresponds to the ozone gas source 106 shown in FIGS. 1,2 and 3.

The main flow line 706 is shown beginning with the sump pump icon 758. The sump pump icon 758 includes the unique text label 786. The sump pump icon 758 is connected to the booster pump icon 760 by the main flow line 706. The booster pump icon 760 includes the unique text label 786. The main flow line 706 includes at least one arrow showing flow from the sump pump icon 758 to the booster pump icon 760. The variable frequency drive display 762 is shown connected to the booster pump icon 760. The variable frequency drive display 762 includes a unique text label 786 and a real-time monitor value 788. In the exemplary display 700, the pointer icon 784 is pointing to the variable frequency drive display 762.

The booster pump icon 760 is connected to the gas injector icon 756 by the main flow line 706. The main flow line 706 includes at least one arrow indicating flow from the booster pump icon 760 to the gas injector icon 756. Several sensor displays 710, 764, 766, 768, 770, 772 are interposed on the main flow line 706. The sensor displays 710, 764, 766, 768, 770, 772 include the first pressure sensor display 710, the first temperature sensor display 764, the flow sensor display 766, the pH sensor display 768, the first ORP sensor display 770, and the first UVA sensor display 772. The sensor displays 710, 764, 766, 768, 770, 772 each include a unique text label 786 and a real-time monitor value 788.

The gas injector icon 756 is connected to the first continuation display 774 by the main flow line 706. The main flow line 706 includes an arrow indicating flow from the booster pump icon 760 to the continuation display 774. The exemplary first continuation display 774 includes an arrow showing continuation of the flow in the same direction as indicated by the main flow line 706. The first continuation display 774 includes the exemplary first continuation text 790 “TO FLASH REACTOR.”

Interposed on the main flow line 706, between the gas injector icon 756 and the first continuation display 774, is the second pressure sensor display 712. The second pressure sensor display 712 includes the unique text label 786 and the real-time monitor value 788.

The gas flow line 708 is shown beginning with the compressor icon 704. The compressor icon 704 includes a unique text label 786. The compressor icon 704 is shown connected to the oxygen concentrator icon 720 by the gas flow line 708. The gas flow line 708 includes at least one arrow showing flow from the compressor icon 704 to the oxygen concentrator icon 720. The third pressure sensor display 714 is interposed on the gas flow line 708. The third pressure sensor display 714 includes the unique text label 786 and the real-time monitor value 788.

The oxygen concentrator icon 720 is shown connected to the oxygen tank icon 722 by the gas flow line 708. The gas flow line 708 includes at least one arrow showing flow from the oxygen concentrator icon 720 to the oxygen tank icon 722.

The oxygen concentrator icon 720 is shown connected to the ozone generation branch point 792 by the gas flow line 708. The gas flow line 708 includes at least one arrow showing flow from the oxygen concentrator icon 720 to the ozone generation branch point 792. The third pressure sensor display 714 is interposed on the gas flow line 708 proximate to and downstream of the oxygen tank icon 722. The third pressure sensor display 714 includes the unique text label 786 and the real-time monitor value 788.

Proximate to and downstream of the third pressure sensor display 714, the first solenoid valve icon 724 is shown connected to the gas flow line 708 by the secondary oxygen flow line 780. The first solenoid valve icon 724 includes the unique text label 786. The secondary oxygen flow line 780 includes at least one arrow showing flow from the gas flow line 708 to the first solenoid valve icon 724. The oxygen sensor display 734 is shown connected to the first solenoid valve icon 724 by the secondary oxygen flow line 780. The secondary oxygen flow line 780 includes at least one arrow showing flow from the first solenoid valve icon 724 to the oxygen sensor display 734. The oxygen sensor display 734 includes the unique text label 786 and the real-time monitor value 788.

On the gas flow line 708, the first flow controller display 736 and the second flow controller display 738 are interposed on the gas flow line 708 proximate to and upstream of the ozone generation branch point 792. The flow controller displays 736, 738 each include the unique text label 786 and the real-time monitor value 788. In the exemplary first display panel 702, the pointer icon 784 is pointing to the second flow controller display 738.

At the ozone generation branch point 792, the gas flow line 708 branches into a first ozone generation flow line 776 and a second ozone generation flow line 778. The ozone generation flow lines 776, 778 converge at the ozone generation convergence point 794.

The first ozone generation flow line 776 connects the ozone generation branch point 792 to the second solenoid valve icon 726. The second solenoid valve icon 726 includes a unique text label 786. The first ozone generation flow line 776 includes at least one arrow showing flow from the ozone generation branch point 792 to the second solenoid valve icon 726.

The second solenoid valve icon 726 is connected to the first ozone generator icon 740 by the first ozone generation flow line 776. The first ozone generator icon 740 includes the unique text label 786. The first ozone generation flow line 776 includes at least one arrow showing flow from the second solenoid valve icon 726 to the first ozone generator icon 740.

The first ozone generator icon 740 is connected to the third solenoid valve icon 728 by the first ozone generation flow line 776. The third solenoid valve icon 728 includes a unique text label 786. The first ozone generation flow line 776 includes at least one arrow showing flow from the third solenoid valve icon 728 to the ozone generation branch point 792 to the ozone generation convergence point 794.

Interposed on the first ozone generation flow line 776 between the third solenoid valve icon 728 and the ozone generation convergence point 794 is the first pressure switch display 744. The first pressure switch display 744 includes the unique text label 786 and the real-time monitor value 788.

The second ozone generation flow line 778 connects the ozone generation branch point 792 to the fourth solenoid valve icon 730. The fourth solenoid valve icon 730 includes the unique text label 786. The second ozone generation flow line 778 includes at least one arrow showing flow from the ozone generation branch point 792 to the fourth solenoid valve icon 730.

The fourth solenoid valve icon 730 is connected to the second ozone generator icon 742 by the second ozone generation flow line 778. The second ozone generator icon 742 includes the unique text label 786. The second ozone generation flow line 778 includes at least one arrow showing flow from the fourth solenoid valve icon 730 to the second ozone generator icon 742.

The second ozone generator icon 742 is connected to the fifth solenoid valve icon 732 by the second ozone generation flow line 778. The fifth solenoid valve icon 732 includes the unique text label 786. The second ozone generation flow line 778 includes at least one arrow showing flow from the fifth solenoid valve icon 732 to the ozone generation convergence point 794.

Interposed on the second ozone generation flow line 778 between the fifth solenoid valve icon 732 and the ozone generation convergence point 794 is the second pressure switch display 746. The second pressure switch display 746 includes the unique text label 786 and the real-time monitor value 788.

The gas flow line 708 connects the ozone generation convergence point 794 to the liquid trap icon 750. The gas flow line 708 includes at least one arrow showing flow from the ozone generation convergence point 794 to the liquid trap icon 750. The liquid trap icon 750 includes the unique text label 786. The level switch display 752 is shown connected to the liquid trap icon 750. The level switch display 752 includes the unique text label 786 and the real-time monitor value 788.

Proximate to and downstream of the ozone generation convergence point 794, the first ozone sensor display 748 is shown connected to the gas flow line 708 by the secondary ozone flow line 782. The first ozone sensor display 748 includes the unique text label 786 and the real-time monitor value 788.

The liquid trap icon 750 is connected to the actuated ball valve icon 754 by the gas flow line 708. The gas flow line 708 includes at least one arrow showing flow from the liquid trap icon 750 to the actuated ball valve icon 754. The actuated ball valve icon 754 includes the unique text label 786.

The actuated ball valve icon 754 is connected to the gas injector 108 by the gas flow line 708. The gas flow line 708 includes at least one arrow showing flow from the actuated ball valve icon 754 to the gas injector icon 756. The fifth pressure sensor display 718 is interposed on the gas flow line 708 between the actuated ball valve icon 754 and the gas injector icon 756. The fifth pressure sensor display 718 includes the unique text label 786 and the real-time monitor value 788.

Referring again to FIG. 7, the sump pump icon 758 indicates the relative location of the sump pump 202 (shown in FIG. 2) and the start of the ozone water treatment system 100. The sump pump icon 758, and all components, sensors and monitors shown in the water treatment system display 700, have a unique text label 786 that identifies that component, sensor or monitor throughout the water treatment system display 700. The main flow line 706 indicates flow through the booster pump icon 760, continuing through the gas injector icon 756, and then to the continuation display 774. The first continuation display 774 indicates that the remainder of the water treatment system display 700 is shown on another display panel, in this example on the second display panel 800 shown in FIG. 8. The booster pump icon 760 corresponds to the relative location of the booster pump 104 (shown in FIGS. 1 and 2), and the gas injector icon 756 corresponds to the relative location of the gas injector 108 (shown in FIGS. 1 and 2).

The variable frequency drive display 762, shown connected to the booster pump icon 760, shows the real time monitor value 788 for the variable frequency drive 204 shown in FIG. 2.

The plurality of sensor displays 710, 764, 766, 768, 770, 772 interposed on the main flow line 706 between the booster pump icon 760 and the gas injector icon 756 show various real-time values 788 of water properties of the water at that location in the water treatment system, i.e. before any treatment has occurred. The first pressure sensor display 710 shows the real-time value 788 of the water pressure. The first temperature sensor display 764 shows the real-time value 788 of the water temperature. The flow sensor display 766 shows the real-time value 788 of the flow rate of the water. The pH sensor display 768 shows the real-time value 788 of the water pH. The first ORP sensor display 770 shows the real-time value 788 of the ORP of the water, and the first UVA sensor display 772 shows the real-time value 788 of the UVA of the water. The plurality of sensor displays 710, 764, 766, 768, 770, 772 correspond to the optional influent water sensors 208 shown in FIG. 2.

The gas injector icon 756 is connected to the first continuation display 774 by the main flow line 706. The first continuation display 774 uses a graphical arrow and the first continuation text 790 “TO FLASH REACTOR” to indicate that the water treatment system display 700 is continued on the second display panel 800 as shown in FIG. 8.

The second pressure sensor display 712, interposed on the main flow line 706 between the gas injector icon 756 and the continuation display 774, shows the pressure in the conduit coupling the gas injector 108 with the mixer 212 (as shown in FIGS. 1 and 2).

The gas flow line 708 shows the components, monitors and sensors comprising the ozone generation section of the ozone water treatment system 100. The gas flow line 708 starts with the compressor icon 704. The compressor icon 704 corresponds to the air compressor 300 shown in FIG. 3. The gas flow line 708 then indicates gas flow continuing from the compressor icon 704 to the oxygen concentrator icon 720 and then to the oxygen tank icon 722. The oxygen concentrator icon 720 corresponds to the oxygen concentrator 306 shown in FIG. 3 and the oxygen tank icon 722 corresponds to the oxygen storage device 308 shown in FIG. 3.

Interposed on the gas flow line 708 between the compressor icon 704 and the oxygen concentrator icon 720 is the third pressure sensor display 714. The third pressure sensor display 714 shows the real-time value 788 of the gas pressure flowing in the conduit between the air compressor 300 and the oxygen concentrator 306, as shown in FIG. 3. The third pressure sensor display 714 corresponds to the compressed air pressure sensor 302 as shown in FIG. 3.

The gas flow line 708 continues from the oxygen tank icon 722 to the ozone generation branch point 792. The embodiment of the present invention as shown in the display 700 corresponds to a parallel dual-generator ozone water treatment system 100, therefore two ozone generator icons 740, 742 and concomitant valves, sensors and conduits are displayed accordingly. The gas flow line 708 branches in order to show the ozone generation flow lines 776, 778 in parallel, each with an integral ozone generator icon 740, 742. In another embodiment of the invention with a single ozone generator, no branching would be necessary. Alternately, another embodiment of the invention comprises three or more ozone generators 322 in parallel as required to supply the ozone water treatment system 100 with the required amount of ozone generation.

As the gas flow line 708 continues downstream from the oxygen tank icon 722, a fourth pressure sensor display 716 is shown. The fourth pressure sensor display 716 shows the real-time value 788 of the oxygen pressure in the gas flow line 708. The fourth pressure sensor display 716 corresponds to the oxygen pressure sensor 312 as shown in FIG. 3. Proximate to and downstream from the fourth pressure sensor display 716, the secondary oxygen flow line 780 is shown connected to the gas flow line 708. The secondary oxygen flow line 780 shows the oxygen gas flow through the first solenoid valve icon 724 and to the oxygen sensor display 734, and corresponds to the dissolved oxygen conduit 314 as shown in FIG. 3. The oxygen sensor display 734 shows the real-time value 788 of the amount of oxygen present in the secondary oxygen flow line 780, and corresponds to the dissolved oxygen sensor 318 as shown in FIG. 3.

Proximate to and upstream of the ozone generation branch point 792, the first and second flow controller displays 736, 738 are shown interposed on the gas flow line 708. The first flow controller display 736 shows the gas flow rate into the first ozone generation flow line 776. The second flow controller display 738 shows the gas flow rate into the second ozone generation flow line 778. The pointer icon 784 indicates. The flow controller displays 736, 738 correspond to the flow controller 122 as shown in FIG. 3.

At the ozone generation branch point 792, the gas flow line 708 splits into two parallel flow lines: the first ozone generation flow line 776 and the second ozone generation flow line 778. The ozone generation flow lines 776, 778 converge at the ozone generation convergence point 794.

The first ozone generation flow line 776 connects, in order, the second solenoid valve icon 726, the first ozone generator icon 740, the third solenoid valve icon 728 and the first pressure switch display 744. The second solenoid valve icon 726 corresponds to the pre-generator valve 320 as shown in FIG. 3. The third solenoid valve icon 728 corresponds to the post-generator valve 326 as shown in FIG. 3, and the first pressure switch display 744 corresponds to the pressure switch 328 as shown in FIG. 3. The first ozone generator icon 740 corresponds to the ozone generator 322 as shown in FIG. 3. The first pressure switch display 744 shows whether the corresponding pressure switch 328 is on or off.

The second ozone generation flow line 778 connects, in order, the fourth solenoid valve icon 730, the second ozone generator icon 742, the fifth solenoid valve icon 732, and the second pressure switch display 746. The fourth solenoid valve icon 730 corresponds to the pre-generator valve 320 as shown in FIG. 3. The fifth solenoid valve icon 732 corresponds to the post-generator valve 326 as shown in FIG. 3, and the second pressure switch display 746 corresponds to the pressure switch 328 as shown in FIG. 3. The second ozone generator icon 742 corresponds to the ozone generator 322 as shown in FIG. 3. The second pressure switch display 746 shows whether the corresponding pressure switch 328 is on or off.

After the ozone generation flow lines 776, 778 converge at the ozone generation convergence point 794, the gas flow line 708 continues from the ozone generation convergence point 794 to the liquid trap icon 750. The liquid trap icon 750 corresponds to the liquid trap 330 as shown in FIG. 3. The level switch display 752 is shown connected to the liquid trap icon 750 and shows whether the level switch 332 is on or off. The level switch display 752 corresponds to the level switch 332 shown in FIG. 3.

Between the ozone generation convergence point 794 and the liquid trap icon 750, the secondary ozone flow line 782 is shown connected to the gas flow line 708. The secondary ozone flow line 782 shows the ozone gas flow to the first ozone sensor display 748. The first ozone sensor display 748 shows the real-time value 788 of the amount of ozone present in the secondary ozone flow line 782. The first ozone sensor display 748 corresponds to the ozone sensor 124 as shown in FIGS. 1 and 3.

Downstream of the liquid trap icon 750, the gas flow line 708 continues to the actuated ball valve icon 754, which corresponds to the actuated ball valve 334 as shown in FIG. 3. The gas flow line 708 continues from the actuated ball valve icon 754 to the gas injector icon 756. The fifth pressure sensor display 718, interposed on the gas flow line 708 between the actuated ball valve icon 754 and the gas injector icon 756, shows the real-time value 788 of the ozone pressure as it is about to enter the gas intake of the gas injector 108 shown in FIGS. 1, 2 and 3. The fifth pressure sensor display 718 corresponds to the ozone pressure sensor 336 as shown in FIG. 3. The gas flow line 708 terminates at the gas injector icon 756.

Referring next to FIG. 8, the second display panel 800 is shown. Shown are a second continuation display 802, the main flow line 706, a sixth pressure sensor display 804, a mixer icon 806, a separator icon 808, an ozone destructor icon 812, a second ozone sensor display 814, a second ORP sensor display 816, a contact chamber icon 818, a second oxygen sensor display 820, a third ORP sensor display 822, a third ozone sensor display 824, a second UVA sensor display 826, a contact time display 828, an effluent display 830, an influent water property display 832, an influent water flow display 834, an influent water pH display 836, an influent water ORP display 838, an influent water UVA display 840, a second temperature display 842, a fourth ozone sensor display 844, a parameter display 846, an ozone output display 848, an applied dose display 850, a transfer efficiency display 852, a transferred dose display 854, a UVA reduction display 856, an ozone demand display 858, a plurality of unique text labels 786, a plurality of real-time monitor values 788, a plurality of display headers 860, a plurality of real-time calculated values 862, a plurality of unit labels 864, a second continuation text 866, a secondary ozone destruct flow line 868, an ambient sensor display 870, and a fifth ozone sensor display 872.

The second display panel 800 continues the display of the ozone water treatment system 100 as begun in FIG. 7. The continuation point is shown by the second continuation display 802. The exemplary second continuation display 802 includes an arrow showing the direction of the continuation of flow from the first continuation display 774 shown in FIG. 7. The second continuation display 802 includes the exemplary second continuation text 866 “FROM VENTURI INJECTOR.”

The second continuation display 802 is connected to the mixer icon 806 by the main flow line 706. The main flow line 706 includes at least one arrow showing flow from the second continuation display 802 to the mixer icon 806. The mixer icon 806 includes the unique text label 786.

Interposed on the main flow line 706, between the second continuation display 802 and the mixer icon 806, is the sixth pressure sensor display 804. The sixth pressure sensor display 804 includes the unique text label 786 and the real-time monitor value 788.

The mixer icon 806 is connected to the separator icon 808 by the main flow line 706. The main flow line 706 includes at least one arrow showing flow from the mixer icon 806 to the separator icon 808. The separator icon 808 includes the unique text label 786.

The separator icon 808 is connected to the contact chamber icon 818 by the main flow line 706. The main flow line 706 includes at least one arrow showing flow from the separator icon 808 to the contact chamber icon 818. The contact chamber icon 818 includes the unique text label 786. As the exemplary contact chamber 118 shown in FIGS. 1 and 2 is a serpentine-type chamber, the contact chamber icon 818 is shown as a simplified serpentine shape.

The secondary ozone destruct flow line 868 connects the separator icon 808 to the ozone destructor icon 812. The ozone destructor icon 812 includes the unique text label 786.

Interposed on the secondary ozone destruct flow line 868, between the separator icon 808 and the ozone destructor icon 812, is the second ozone sensor display 814. The second ozone sensor display 814 includes the unique text label 786 and the real-time monitor value 788.

Interposed on the main flow line 706, between the separator icon 808 and the contact chamber icon 818, is the third ozone sensor display 824 and the second ORP sensor display 816. The third ozone sensor display 824 and the second ORP sensor display 816 each include the unique text label 786 and the real-time monitor value 788.

Interposed on the contact chamber icon 818 are the third ORP sensor display 822, the second oxygen sensor display 820, the fourth ozone sensor display 844, the second UVA sensor display 826, and the contact time display 828. Each of the sensor displays 820, 822, 826, 844 includes the unique text label 786 and the real-time monitor value 788. The contact time display 828 includes the text “CONTACT TIME” and a time value.

The main flow line 706 connects the contact chamber icon 818 to the effluent display 830. The effluent display 830 includes an arrow indicating flow exiting from the contact chamber icon 818. The effluent display 830 includes the text “TO MAIN PROCESS.”

The influent water property display 832 is shown unconnected to the main flow line 706. The influent water property display 832 includes the influent water flow display 834, the influent water pH display 836, the influent water ORP display 838, and the influent water UVA display 840. Each of the sensors 834, 836, 838, 840 includes the unique text label 786 and the real-time monitor value 788.

The parameter display 846 is shown unconnected to the main flow line 706. The parameter display 846 includes the ozone output display 848, the applied dose display 850, the transfer efficiency display 852, the transferred dose display 854, the UVA reduction display 856, and the ozone demand display 858. Each of the displays 848, 850, 852, 854, 856, 858 includes the display header 860, the real-time calculated value 862 and the unit label 864.

The ambient sensor display 870 is shown unconnected to the main flow line 706. The ambient sensor display 870 includes the second temperature display 842 and the fifth ozone sensor display 872. The sensor displays 842, 872 include the unique text label 786 and the real-time monitor value 788.

The ozone demand display 858 is shown unconnected to the main flow line 706. The ozone demand display 858 includes the display header 860, the real-time calculated value 862 and the unit label 864.

Referring again to FIG. 8, as previously described the second continuation display 802 indicates the continuation of the water treatment system display 700 from FIG. 7. As described previously, the separation of the water treatment system display 700 into two display panels 702 and 800 as shown in FIGS. 7 and 8 has no relation to the ozone water treatment system 100, which remains an integral system.

As previously described in FIG. 7, the icons, sensors and monitors have unique text labels 786 that identify that icon, sensor or monitor throughout the water treatment system display 700.

The second continuation display 802 indicates that the water flow on the second display panel 800 is continued from the discharge of the gas injector icon 756 shown in FIG. 7. The main flow line 706 indicates the water flowing through the mixer icon 806 and continuing to the separator icon 808. The mixer icon 806 corresponds to the mixer 212 shown in FIG. 2. The separator icon 808 refers to the separator 214 shown in FIG. 2. The sixth pressure sensor display 804, interposed on the main flow line 706 between the second continuation display 802 and the mixer icon 806, shows the real-time value 788 of the water pressure in the conduit between the gas injector 108 and the mixer 212 (as shown in FIG. 2).

The main flow line 706 is shown continuing from the separator icon 808 to the contact chamber icon 818. The third ozone sensor display 824, interposed on the main flow line 706 between the separator icon 808 and the contact chamber icon 818, shows the amount of ozone in the water after exiting the separator 214 but prior to entering the contact chamber 118 (as shown in FIG. 2). The second ORP sensor display 816, also interposed on the main flow line 706 between the separator icon 808 and the contact chamber icon 818, shows the oxidation-reduction potential of the water after exiting the separator 214 but prior to entering the contact chamber 118 (as shown in FIG. 2).

The secondary ozone destruct flow line 868 connecting the separator icon 808 to the ozone destructor icon 812 illustrates the flow of excess undissolved ozone gas from the separator 214 (shown in FIG. 2.) to the ozone destructor 116 (shown in FIGS. 1 and 2). The ozone destructor icon 812 corresponds to the ozone destructor 116 (shown in FIGS. 1 and 2).

The second ozone sensor display 814, interposed on the secondary ozone destruct flow line 868 between the separator icon 808 and the ozone destructor icon 812, shows the real-time value of the amount of undissolved ozone to be destroyed.

The contact time display 828 is shown interposed on the contact chamber icon 818. The contact time display 828 shows the contact time, i.e. the length of time the treatment water has been in the contact chamber 118, for the sensor displays 820, 822, 826, 824. The third ORP sensor display 822 shows the oxidation-potential of the water at the contact time shown on the contact time display 828. The second oxygen sensor display 820 shows the amount of oxygen in the water at the contact time shown on the contact time display 828. The third ozone sensor display 824 shows the amount of ozone in the water at the contact time shown on the contact time display 828. The second UVA sensor display 826 shows the UVA value of the water at the contact time shown on the contact time display 828.

The main flow line 706 connecting the contact chamber icon 818 to the effluent display 830 shows the treated water being discharged into the general water system, to additional treatment, or into the environment.

The influent water property display 832 shows relevant influent water properties on the second display panel 800. This allows the user to visually compare treated water properties with the influent water properties without having to return to the first display panel 702. The influent water property display 832 includes the influent water flow display 834 (showing the influent water flow rate), the influent water pH display 836 (showing the pH of the influent water), the influent water ORP display 838 (showing the oxidation-reduction potential of the influent water), and the influent water UVA display 840 (showing the UVA value of the influent water).

The parameter display 846 shows real-time values and units of measurement of properties of the ozone treatment, and includes the ozone output display 848, the applied dose display 850, the transfer efficiency display 852, the transferred dose display 854, and the UVA reduction display 856. The properties are calculated by the programmable logic controller (PLC) 130 using sensor values and user-input algorithms. Each display 848, 850, 852, 854 includes the display header 860 (indicating the parameter shown), the real-time calculated value 862, and the unit label 864. The ozone output display 848 shows the amount of ozone produced by the ozone gas source 106. The applied dose display 850 shows the amount of generated ozone applied to the influent water source 102. The transfer efficiency display 852 shows the percentage of applied ozone that is dissolved into the influent water source 102. The transferred dose display 854 shows the amount of ozone dissolved in the influent water source 102. The UVA reduction display 856 shows the reduction in UVA between the influent water source 102 and the water in the contact chamber 118.

The ambient sensor display 870 includes the second temperature display and the fifth ozone sensor display 872.

The ozone demand display 858 includes the display header 860 (indicating the parameter shown), the real-time calculated value 862, and the unit label 864. The ozone demand display 858 shows the amount of ozone used by the ozone water treatment system 100 and the unit of measurement.

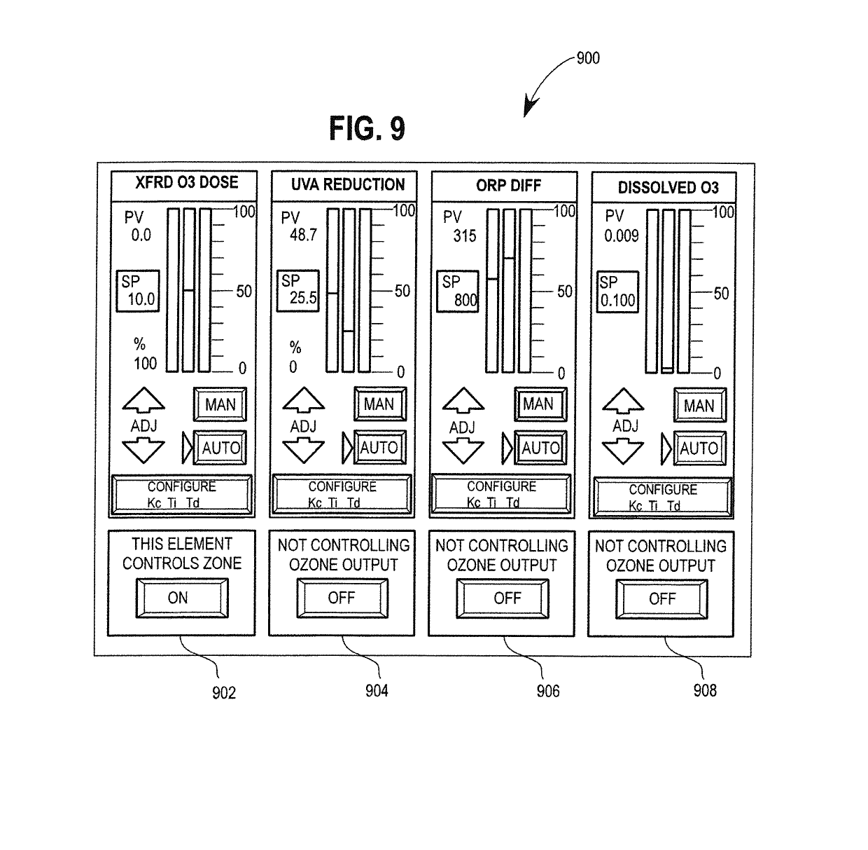

Referring next to FIG. 9, an exemplary user interface control panel display 900 is shown. Shown are a transferred ozone dose display column 902, a SUVA reduction display column 904, an ORP differential display column 906 and a dissolved ozone display column 908. In the present embodiment of the invention, the user interface control panel display 900 is rectangular with a landscape orientation. The display columns 902, 904, 906, 908 have a portrait orientation and are arrayed in a single row on the user interface control panel display 900. The skilled artisan will note that many variations in type, number and graphics of display columns are possible, and are not limited by the number, type and graphics of display columns shown in FIG. 9. In the present embodiment of the invention the user interface control panel display 900 is a touchscreen-type display, but it would be readily apparent to those skilled in the art that user input may be made using a mouse, keyboard, or other suitable method.

Each of the display columns 902, 904, 906, 908 provides real-time monitoring of the water quality indicated in that specific display column 902, 904, 906, 908. The display columns 902, 904, 906, 908 also provide user interfaces for controlling inputs related to that specific display column. For example, the transferred ozone dose display column 902 shows real-time information related to the transferred ozone dose and provides user interfaces for controlling the transferred ozone dose. The layout and function of the exemplary transferred ozone dose display column 902 is described in FIG. 10 below.

Referring next to FIG. 10, the transferred ozone dose display column 902 is shown. Shown are a transferred ozone dose title cell 1000, a transferred ozone dose title 1002, a transferred ozone dose monitor cell 1004, a transferred ozone dose PV indicator 1006, a transferred ozone dose SP indicator 1008, a transferred ozone dose percent indicator 1010, a transferred ozone dose PV bar gauge 1012, a transferred ozone dose SP bar gauge 1014, a transferred ozone dose percent bar gauge 1016, a transferred ozone dose scale 1018, a transferred ozone dose manual/auto adjustment cell 1020, a transferred ozone dose manual button 1022, a transferred ozone dose auto button 1024, a transferred ozone dose manual/auto indicator arrow 1026, a top transferred ozone dose adjustment arrow 1028, a bottom transferred ozone dose adjustment arrow 1030, a transferred ozone dose adjustment label 1032, a transferred ozone dose process control configuration cell 1034, a transferred ozone dose process control configuration button 1036, a transferred ozone dose process control configuration label 1038, a transferred ozone dose on/off cell 1040, a transferred ozone dose on/off label 1042, and a transferred ozone dose on/off button 1044.

As mentioned previously in FIG. 9, in the present embodiment of the invention, the transferred ozone dose display column 902 is oriented vertically, with an approximate height-to-width ratio of 4:1. The transferred ozone dose display column 902 is partitioned into a plurality of cells. In the present embodiment of the invention, the cells are stacked vertically in the transferred ozone dose display column 902, forming a single column where each cell extends the full width of the transferred ozone dose display column 902. It will be readily apparent to those skilled in the art that other column and cell configurations, for example one where cells are located side-by-side in a column, are possible.

In the present embodiment of the invention, the cells are ordered from top to bottom in the following configuration: the transferred ozone dose title cell 1000, the transferred ozone dose monitor cell 1004, the transferred ozone dose manual/auto adjustment cell 1020, the transferred ozone dose process control configuration cell 1034, and the transferred ozone dose on/off cell 1040.

The transferred ozone dose title cell 1000 contains the transferred ozone dose title 1002. In one embodiment of the invention, the transferred ozone dose title 1002 includes the text “XFRD 03 DOSE.”

The transferred ozone dose monitor cell 1004 includes the transferred ozone dose PV indicator 1006, the transferred ozone dose SP indicator 1008, the transferred ozone dose percent indicator 1010, the transferred ozone dose PV bar gauge 1012, the transferred ozone dose SP bar gauge 1014, the transferred ozone dose percent bar gauge 1016, and the transferred ozone dose scale 1018. In the present embodiment of the invention, the transferred ozone dose monitor cell 1004 has an approximate height-to-width ratio of 2:1.

In the present embodiment of the invention, the plurality of transferred ozone dose indicators 1006, 1008, 1010 are shown proximate to the left edge of the transferred ozone dose monitor cell 1004. The transferred ozone dose indicators 1006, 1008, 1010 are arranged vertically. The transferred ozone dose PV indicator 1006 is the top ozone dose indicator. The transferred ozone dose PV indicator 1006 contains a PV label 1046 and a PV number value 1048. In the present embodiment of the invention, the PV label 1046 is the text “PV”. In the exemplary transferred ozone dose monitor cell 1004, the PV number value 1048 is 0.0. The transferred ozone dose PV indicator 1006 is denoted by a color. In this example, the transferred ozone dose PV indicator 1006 is denoted by the color red.

The transferred ozone dose SP indicator 1008 is located below the transferred ozone dose PV indicator 1006. The transferred ozone dose SP indicator 1008 contains a SP label 1050 and a SP number value 1052. In the present embodiment of the invention, the SP label 1050 is the text “SP”. In the exemplary transferred ozone dose monitor cell 1004, the SP number value 1052 is 10.0. The transferred ozone dose SP indicator 1008 is denoted by a color. In this example, the transferred ozone dose SP indicator 1008 is denoted by the color green.

The transferred ozone dose percent indicator 1010 is located below the transferred ozone dose PV indicator 1006. The transferred ozone dose percent indicator 1010 contains a percent label 1054 and a percent number value 1056. In the present embodiment of the invention, the percent label 1054 is the text “%”. In the exemplary transferred ozone dose monitor cell 1004, the percent number value 1056 is 100. The transferred ozone dose percent indicator 1010 is denoted by a color. In this example, the transferred ozone dose percent indicator 1010 is denoted by the color white.

In one embodiment of the invention, the bar gauges 1012, 1014, 1016 are located to the right of and proximate to the transferred ozone dose indicators 1006, 1008, 1010. Each bar gauge 1012, 1014, 1016 is comprised of a thin vertically-oriented rectangle. The tops of the bar gauges 1012, 1014, 1016 are proximate to the top edge of the transferred ozone dose monitor cell 1004 and the bottoms of the bar gauges 1012, 1014, 1016 are proximate to the bottom edge of the transferred ozone dose monitor cell 1004. The bar gauges 1012, 1014, 1016 are arrayed in a single row. In the exemplary transferred ozone dose display column 902, the transferred ozone dose PV bar gauge 1012 is leftmost, the transferred ozone dose SP bar gauge 1014 is center, and the transferred ozone dose percent bar gauge 1016 is rightmost. The bar gauges 1012, 1014, 1016 include a background color and an indicator color. In the exemplary transferred ozone dose display column 902, the bar gauge 1012, 1014, 1016 background color is dark gray. The bar gauge 1012, 1014, 1016 level color is the same as the corresponding indicator 1006, 1008, 1010 color, i.e. the level color for the transferred ozone dose PV bar gauge 1012 is red, the level color for the transferred ozone dose SP bar gauge 1014 is green, and the level color for the transferred ozone dose percent bar gauge 1016 is white.

As the values of SP, PV and percent increase, the amount of analogous indicator color increases from the bottom up. In the exemplary transferred ozone dose display column 902, the PV number value 1048 shown by the transferred ozone dose PV indicator 1006 is 0.0, thus the transferred ozone dose PV bar gauge 1012 is comprised solely of background color. The SP number value 1052 shown by the transferred ozone dose SP indicator 1008 is 10.0, thus the transferred ozone dose SP bar gauge 1014 includes a lower portion with the level color and an upper portion with the background color. The percent number value 1056 shown by the transferred ozone dose percent indicator 1010 is 100.0, thus the transferred ozone dose percent bar gauge 1016 is comprised solely of level color.

The transferred ozone dose scale 1018 is located proximate to the right edge of the transferred ozone dose monitor cell 1004. The transferred ozone dose scale 1018 includes a plurality of tick marks 1058 and a plurality of scale numbers 1060. The plurality of tick marks 1058 are short lines oriented perpendicular to the bar gauges 1012, 1014, 1016 and are evenly spaced along the bar gauges 1012, 1014, 1016. Some tick marks 1058 may be longer or thicker than the typical tick marks 1058 to indicate major units of measurement. The uppeimost tick mark 1058 is level with the tops of the bar gauges 1012, 1014, 1016 and the bottommost tick mark 1058 is level with the bottoms of the bar gauges 1012, 1014, 1016. The plurality of scale numbers 1060 are located so that a single tick mark 1058 corresponds to a single scale number 1060. The scale numbers 1060 indicate a user-designated numerical range corresponding to the top and bottom tick marks 1058. Intermediate scale numbers 1060 corresponding to intermediate tick marks 1058 may be shown.

The transferred ozone dose manual/auto adjustment cell 1020 includes the transferred ozone dose manual button 1022, the transferred ozone dose auto button 1024, the transferred ozone dose manual/auto indicator arrow 1026, the top transferred ozone dose adjustment arrow 1028, the bottom transferred ozone dose adjustment arrow 1030, the transferred ozone dose adjustment label 1032, the transferred ozone dose process control configuration button 1036, and the transferred ozone dose process control configuration label 1038.

In one embodiment, the transferred ozone dose manual button 1022 and the transferred ozone dose auto button 1024 are located proximate to the right edge of the transferred ozone dose manual/auto adjustment cell 1020 and stacked vertically. The transferred ozone dose manual button 1022 is rectangular in shape, with the text “MAN” superimposed on the transferred ozone dose manual button 1022. The transferred ozone dose auto button 1024 is rectangular in shape, with the text “AUTO” superimposed on the transferred ozone dose auto button 1024. The transferred ozone dose manual button 1022 is located above the transferred ozone dose auto button 1024.

The transferred ozone dose manual/auto indicator arrow 1026 is located left of and proximate to the transferred ozone dose manual button 1022 and the transferred ozone dose auto button 1024. The transferred ozone dose manual/auto indicator arrow 1026 points to either the transferred ozone dose manual button 1022 or the transferred ozone dose auto button 1024.

In one embodiment, the top transferred ozone dose adjustment arrow 1028 and the bottom transferred ozone dose adjustment arrow 1030 are located proximate to the left edge of the transferred ozone dose manual/auto adjustment cell 1020. The top transferred ozone dose adjustment arrow 1028 points upward and is located above the bottom transferred ozone dose adjustment arrow 1030, which points downward. The transferred ozone dose adjustment label 1032 is located between the transferred ozone dose adjustment arrows 1028, 1030 and is comprised of the text “ADJ”.

The transferred ozone dose process control configuration button 1036 is located proximate to the bottom edge of the transferred ozone dose manual/auto adjustment cell 1020 and includes the transferred ozone dose process control configuration label 1038. The transferred ozone dose process control configuration button 1036 is rectangular in shape. The transferred ozone dose process control configuration label 1038 is comprised of the upper text “CONFIGURE” and the lower text “Kc Ti Td.”

In one embodiment of the invention, the transferred ozone dose on/off cell 1040 includes the transferred ozone dose on/off label 1042 and the transferred ozone dose on/off button 1044. The transferred ozone dose on/off label 1042 is located proximate to the top edge of the transferred ozone dose on/off cell 1040. The transferred ozone dose on/off label 1042 includes either the text “THIS ELEMENT CONTROLS OZONE” or the text “NOT CONTROLLING OZONE OUTPUT.” The transferred ozone dose on/off button 1044 is located below the transferred ozone dose on/off cell 1040 and is rectangular in shape. The text superimposed on the transferred ozone dose on/off button 1044 includes either “ON” or “OFF.”

Referring again to FIG. 10, as stated previously the transferred ozone dose display column 902 displays real-time data related to the transfer efficiency process control 500, previously shown in FIG. 5. The transferred ozone dose display column 902 also provides a user interface whereby the user controls the regulation of the ozone water treatment system 100.

The transferred ozone dose title cell 1000 and the included transferred ozone dose title 1002 denote the type of process control displayed in the column and governed by the user interface. In this exemplary transferred ozone dose display column 902, the text of the transferred ozone dose title 1002, “XFRD 03 DOSE,” refers to the transfer efficiency process control 500 previously described in FIG. 5.

The transferred ozone dose monitor cell 1004 includes components that display real-time data related to the transfer efficiency process control 500. The transferred ozone dose PV indicator 1006 shows the real-time level of PV. The transferred ozone dose SP indicator 1008 shows the real-time level of SP. The transferred ozone dose percent indicator 1010 shows the real-time value of the transferred ozone dose.

The bar gauges 1012, 1014, 1016 provide a graphical representation of the values shown by the transferred ozone dose indicators 1006, 1008, 1010. The adjacent transferred ozone dose scale 1018 provides a linear scale with which to measure the bar gauges 1012, 1014, 1016 against. The color of the bar gauges 1012, 1014, 1016 matches the color of the corresponding transferred ozone dose indicator 1006, 1008, 1010, clearly indicating their association.

The transferred ozone dose manual/auto adjustment cell 1020 provides user input for toggling between manual and automatic control of the transferred ozone dose and also for adjusting the transferred ozone dose level. The user selection of the transferred ozone dose auto button 1024 results in control of the transferred ozone dose level by the transfer efficiency process control 500 previously shown in FIG. 5. The user selection of the transferred ozone dose manual button 1022 results in control of the transferred ozone dose level by the user. The transferred ozone dose manual/auto indicator arrow 1026 is shown pointing to the currently selected button 1022, 1024, i.e. if the transferred ozone dose auto button 1024 has been selected the transferred ozone dose manual/auto indicator arrow 1026 points to the transferred ozone dose auto button 1024. The user increases the transferred ozone dose level by selecting the top transferred ozone dose adjustment arrow 1028, which will increase the ozone dose by a user-specified amount. The user decreases the transferred ozone dose level by selecting the bottom transferred ozone dose adjustment arrow 1030, which will decrease the ozone dose by a user-specified amount.

The transferred ozone dose process control configuration button 1036 provides user input for adjusting the numerical constants used in the transfer efficiency process control 500. Selection of the transferred ozone dose process control configuration button 1036 results in the display of an additional input display. The user can adjust numerical constants Kc (proportional constant), Ti (time-related constant) and Td (rate of change constant).

The transferred ozone dose on/off cell 1040 provides user input for determining whether the transferred ozone dose display column 902 inputs are used to control the ozone dose. Selecting the transferred ozone dose on/off button 1044 toggles it to the opposite position, i.e. selecting the button 1044 when the button 1044 text reads “ON” toggles the button 1044 to the off position and changes the button 1044 text to “OFF.” The transferred ozone dose on/off label 1042 is also toggled when the transferred ozone dose on/off button 1044 is selected, i.e. when the button 1044 text reads “OFF”, the transferred ozone dose on/off label 1042 reads “NOT CONTROLLING OZONE OUTPUT,” and when the button 1044 text reads “ON”, the transferred ozone dose on/off label 1042reads “THIS ELEMENT CONTROLS OZONE.” The transferred ozone dose on/off label 1042 provides a clear indication of whether the inputs in the transferred ozone dose display column 902 are controlling the ozone dose.

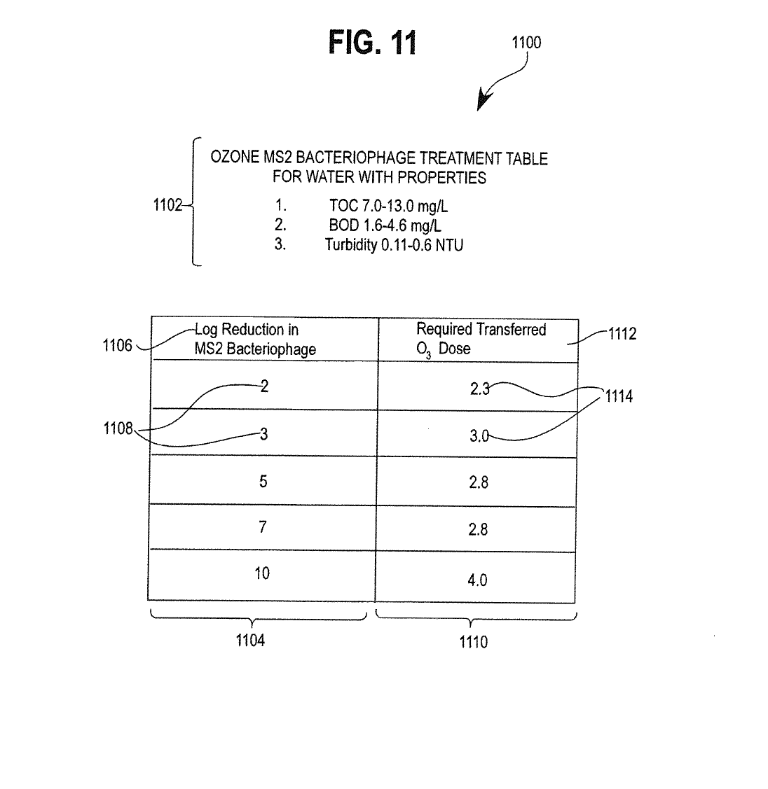

Referring next to FIG. 11, an additional embodiment of the present invention is shown. FIG. 11 shows an exemplary ozone dose table 1100. The ozone dose table 1100 includes a table property summary header 1102, a criteria column 1104, a criteria column header 1106, a plurality of criteria values 1108, an ozone dose column 1110, an ozone dose column header 1112 and a plurality of ozone dose values 1114.

The table property summary header 1102 shows the influent water quality properties and pathogen or contaminant type applicable to the ozone dose table 1100. The influent water quality properties are derived from a prior analysis of the influent water source 102 and the ozone water treatment system 100.

Next, the criteria column 1104 and the ozone dose column 1110 are located in the ozone dose table 1100 so that their rows align. The first row of the criteria column 1104 is the criteria column header 1106. The remaining rows of the criteria column 1104 contain a plurality of criteria values 1108, with one criteria value 1108 per criteria column 1104 row. The first row of the ozone dose column 1110 is the ozone dose column header 1112. The remaining rows of the ozone dose column 1110 contain a plurality of ozone dose values 1114, with one ozone dose value 1114 per ozone dose column 1110 row. The criteria column 1104 and the ozone dose column 1110 have the same number of rows so that each criteria value 1108 corresponds to an ozone dose value 1114 in the same row.

In the exemplary criteria column 1104, the criteria column header 1106 indicates that the criteria values 1108 correspond to a log reduction in the MS2 bacteriophage pathogen. Other pathogens or contaminants, for example poliovirus, may be indicated by the criteria column header 1106. The plurality of criteria values 1108 designate various target values of the criteria given in the criteria column header 1106. In the exemplary criteria column 1104, the ozone dose column header 1112 indicates that the ozone dose values 1114 correspond to an applied ozone dose to be applied to the ozone water treatment system 100. To determine the required ozone dose for an ozone water treatment system 100, the desired contaminant or pathogen reduction value is found in the criteria column 1104. The corresponding ozone dose value 1114 in the same row is the ozone dose that results in desired contaminant or pathogen reduction. The required ozone dose is then entered manually into the ozone water treatment system 100 or used as part of one or more of the process controls 400, 500.

While the invention herein disclosed has been described by means of specific embodiments, examples and applications thereof, numerous modifications and variations could be made thereto by those skilled in the art without departing from the scope of the invention set forth in the claims.

What is claimed is:

1. A water treatment system comprising:
a plurality of monitoring sensors tracking properties in real-time;
a controller controlling ozone output in response to the plurality of monitoring sensors tracking properties and in response to an ozone dose table for determining ozone dosage based on pathogen and contaminant limits for effluent water.

2. The water treatment system of claim 1 wherein said plurality of monitoring sensors comprises an ozone sensor.

3. The water treatment system of claim 2 wherein said plurality of monitoring sensors comprises a flow rate sensor.

4. The water treatment system of claim 2 wherein said plurality of monitoring sensors comprises an excess ozone sensor.

5. The water treatment system of claim 2 wherein said controller controlling ozone output comprises:
a flow controller controlling a flow rate of ozone output.

6. The water treatment system of claim 5 further comprising:
an ozone gas source coupled to said flow controller, and generating ozone of an amount in response to said flow controller.

7. The water treatment system of claim 6 further comprising:
a gas injector coupled to said ozone gas source injecting said ozone having been generated into a fluid stream.

8. The water treatment system of claim 7 wherein said plurality of monitoring sensors comprises a flow rate sensor sensing a flow rate in said fluid stream.

9. The water treatment system of claim 7 further comprising a mixer/separator phase mixing said ozone into said fluid stream and separating undissolved ozone gas from said fluid stream.

10. The water treatment system of claim 9 further comprising:
a contact chamber coupled to said mixer/separator phase providing additional contact time of said ozone in said fluid stream.

11. The water treatment system of claim 9 further comprising an ozone destructor coupled to said mixer/separator phase destroying said undissolved ozone gas from said fluid stream.

12. The water treatment system of claim 11 wherein said plurality of monitoring sensors further comprises an excess ozone sensor interposed between said mixer/separator phase and said ozone destructor.

13. The water treatment system of claim 7 further comprising:
a booster pump coupled to said gas injector.

14. The water treatment system of claim 6 further comprising a gas injector coupled to said ozone gas source and injecting said amount of said ozone into a fluid stream.

15. A water treatment method comprising:
sensing in real-time;
generating a plurality of sensor outputs in response to said sensing;
controlling ozone output in response to the plurality of sensor outputs and in response to an ozone dose table for determining ozone dosage based on pathogen and contaminant limits for effluent water.

16. The water treatment method of claim 15 wherein said sensing comprises an amount of ozone generated by an ozone gas source.

17. The water treatment method of claim 16 wherein said sensing comprises sensing a flow rate of a fluid stream.

18. The water treatment method of claim 16 wherein said sensing comprises sensing an amount of excess ozone.

19. The water treatment method of claim 16 further comprising:
controlling a flow rate of ozone output.

20. The water treatment method of claim 19 further comprising:
generating ozone of an amount in response to said controlling.
